(19) United States
(12) Patent Application Publication
(10) Pub. No.: US 2026/0288909 A1
(43) Pub. Date: Sep. 24, 2026

(54) SYSTEM

(71) Applicant: SoftBank Group Corp., Tokyo (JP)

(72) Inventor: Tatsuya SUZUKI, Tokyo (JP)

(73) Assignee: SoftBank Group Corp., Tokyo (JP)

(21) Appl. No.: 19/562,813

(22) Filed: Mar. 11, 2026

(30) Foreign Application Priority Data
Mar. 19, 2025 (JP) 2025-044956

(51) Int. Cl. G06F 18/243; G06N 3/0475; H04L 9/40

(52) U.S. Cl. CPC G06F 18/243; G06N 3/0475; H04L 63/0428

(57) ABSTRACT

A system includes a processor that is configured to; use a virtual private network connection to securely receive information from a user, generate, by using a generative artificial intelligence model, a prompt sentence for analyzing the received information and extract important words from the received information, and automatically classify the information into an appropriate service or department based on the extracted words.

### CROSS-REFERENCE TO RELATED APPLICATION

This application is based on and claims priority under 35 USC 119 from Japanese Patent Application No. 2025-044956 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional information handling systems used in enterprises and organizations, user-submitted information such as inquiries, requests, and incident reports is often received through unsecured or semi-secured channels and then manually reviewed by operators. As a result, several problems arise. First, there is a risk that sensitive information may be exposed during transmission or processing when the communication path is not adequately protected. Second, a human operator is typically required to read and interpret the content of each submission, decide which department or service should handle it, and then forward it, which causes delays, increases operational cost, and leads to inconsistent classification depending on the individual operator's judgment and workload. Third, even when artificial intelligence technologies are used, many systems do not perform sufficiently fine-grained analysis of the content, such as accurately extracting important words or concepts that are necessary for correct routing. Fourth, many existing systems fail to provide an automatic, high-quality response to the user that is tailored to the specific content of the classified information, thereby requiring additional human intervention. Fifth, conventional systems frequently ignore the emotional state of the user, and therefore responses may appear insensitive, overly rigid, or otherwise inappropriate to the user's psychological condition, which can degrade user satisfaction and trust. Accordingly, there is a need for a system that can securely receive user information, automatically analyze and classify that information using a generative artificial intelligence model, generate an appropriate response, and further adjust the response according to the user's emotional state, thereby improving security, efficiency, accuracy, and user experience in information handling operations.

### SUMMARY

In order to solve the above-described problems, the present invention provides a system comprising a processor, wherein the processor is configured to use a virtual private network connection to securely receive information from a user, thereby ensuring that communication between the user and the system is protected against unauthorized access and interception. The processor is further configured to generate, by using a generative artificial intelligence model, a prompt sentence for analyzing the received information and to extract important words from the received information, thereby enabling fine-grained semantic understanding of the content. Based on the extracted important words, the processor is configured to automatically classify the information into an appropriate service or department, so that routing no longer depends on manual judgment and can be performed quickly and consistently. In one aspect of the invention, the processor is further configured to generate, by using the generative artificial intelligence model and based on the classified information, a response to the user, such that content-aware replies can be automatically produced without requiring human operators to draft individual responses. In another aspect of the invention, the processor is further configured to analyze an emotional state of the user and adjust the response based on a result of the analysis, so that the tone, level of detail, and structure of the response are dynamically adapted to the user's psychological condition. By virtue of these configurations, the system according to the present invention can simultaneously achieve secure reception of user information, accurate and automated classification to the appropriate service or department, generation of suitable responses, and emotional adaptation of those responses, thereby resolving the aforementioned issues of security, efficiency, classification accuracy, and user satisfaction.

The term “system” refers to an integrated combination of hardware, software, and communication components that cooperate to perform the functions recited in the claims, including receiving, analyzing, classifying, and responding to information from a user.

The term “processor” refers to one or more hardware processing units, such as a central processing unit (CPU), a microprocessor, a digital signal processor, a graphics processing unit (GPU), or a combination thereof, that executes instructions to perform the operations specified in the claims.

The term “virtual private network connection” refers to a logical communication channel established over a public or shared network, in which data is encrypted or otherwise protected so that communication between the user and the system is treated as if it occurs over a private, secure network.

The term “securely receive information” refers to receiving information in a manner that protects the confidentiality and integrity of the information during transmission and reception, for example by using encryption, authentication, and access control mechanisms.

The term “user” refers to any individual or entity that provides information to the system, for example an employee, customer, operator, or automated client acting on behalf of an individual or organization.

The term “information” refers to any data, message, text, or content submitted or provided by the user to the system, including but not limited to inquiries, requests, reports, instructions, or feedback.

The term “generative artificial intelligence model” refers to a machine learning model, such as a large language model or other generative model, that is configured to produce new content, including text such as prompt sentences and responses, based on input data.

The term “prompt sentence” refers to a text or sequence of tokens generated for use as input to the generative artificial intelligence model, which instructs or guides the model in analyzing the received information and extracting relevant content.

The term “analyzing the received information” refers to processing the received information to determine its content, structure, and meaning, including identifying key concepts, topics, or intents contained in the information.

The term “important words” refers to words, phrases, or tokens extracted from the received information that are determined to be significant for understanding, classifying, or routing the information, for example keywords representing topics, entities, or actions.

The term “extract important words” refers to identifying and selecting, from the received information, those words or phrases that are deemed relevant for subsequent processing, such as classification or response generation.

The term “automatically classify” refers to assigning the received information, without manual intervention, to one or more categories, labels, services, or departments based on a predetermined rule set, a machine learning model, or a combination thereof.

The term “appropriate service or department” refers to a functional unit, organizational group, or system component that is responsible for handling, processing, or responding to the type of information indicated by the extracted important words.

The term “classified information” refers to the information that has been assigned, by the system, to one or more categories, services, or departments as a result of the automatic classification process.

The term “response to the user” refers to information generated by the system and provided back to the user, such as an answer, guidance, instruction, confirmation, or follow-up question, based on the classified information.

The term “emotional state of the user” refers to an inferred psychological or affective condition of the user, such as frustration, satisfaction, urgency, calmness, or confusion, as estimated from the user's information, behavior, or other observable signals.

The term “analyze an emotional state of the user” refers to processing the user's information, including text or other signals, to estimate or classify the user's emotional condition using rules, models, or algorithms.

The term “adjust the response” refers to modifying at least one aspect of the response to the user, such as tone, wording, level of detail, structure, or content, in accordance with the analyzed emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

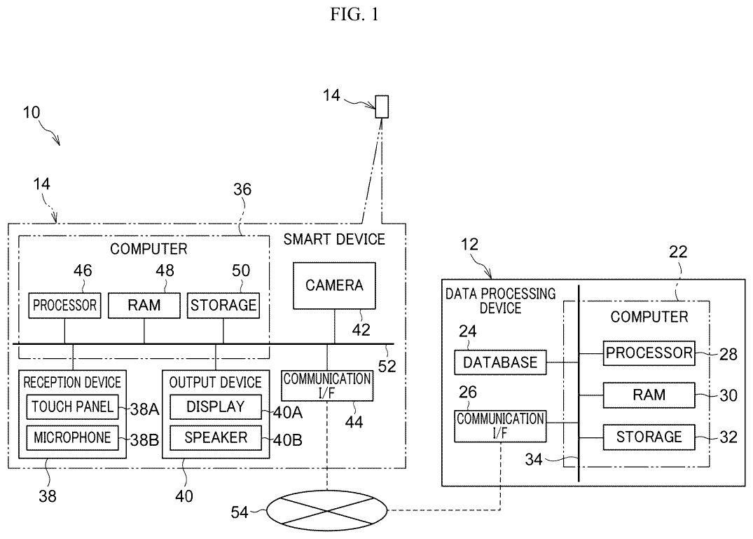

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

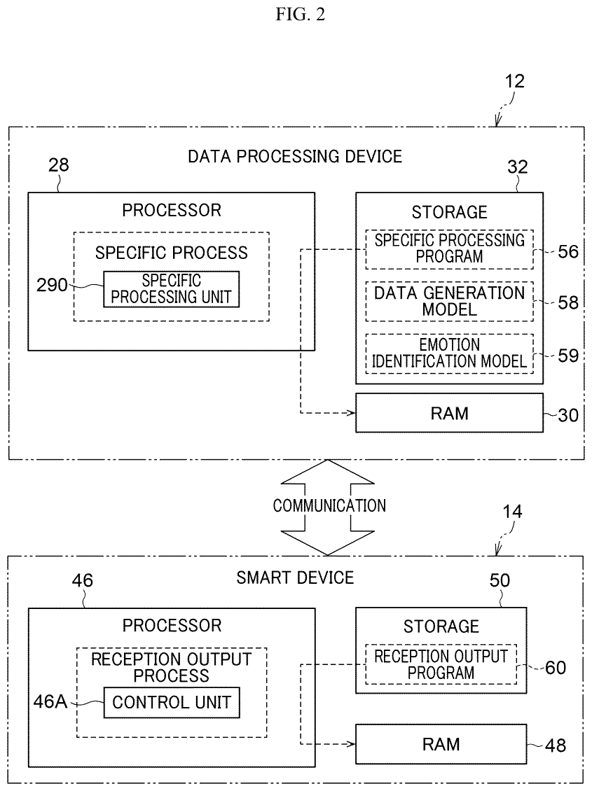

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that provide natural language responses to user queries over a network often suffer from several technical limitations. First, when such systems are operated over public communication networks, the handling of user queries and associated sensitive data may be vulnerable to interception or tampering, thereby degrading security at the network and application layers. Second, existing dialog systems that rely on generative AI models typically treat the model as a standalone component, without tightly integrating retrieval of enterprise data, association of precise information sources, and management of model inputs in a structured manner. As a result, the systems may produce responses that are slow, poorly grounded in authoritative data, or difficult for the user to verify.

In many architectures, the server receives a user message, forwards it directly to a generative AI model, and returns the raw model output. Such architectures generally do not systematically construct extended prompt sentences that incorporate selected retrieved information with explicit source identifiers, do not effectively reuse frequently requested responses, and do not continuously adapt retrieval weighting and model control parameters based on accumulated interaction logs. Consequently, the overall system performance in terms of latency, resource utilization, and response accuracy is suboptimal, and the burden on network bandwidth and processing units increases as the volume of user queries grows.

Furthermore, conventional systems frequently lack a robust mechanism to record past prompt sentences, response sentences, search results, and user evaluation information in a unified manner, and to use that recorded information to dynamically optimize both the retrieval process and the response generation process. Without such mechanisms, the system cannot effectively refine its behavior at the server side, for example by adjusting index weighting parameters, modifying input data construction logic, or tuning inference conditions for the generative AI model. This limits the ability of the system to improve over time as more interactions occur.

Accordingly, there is a need for an improved server-side information processing technique that (i) securely receives user information via an encrypted communication channel, (ii) cooperatively controls a retrieval subsystem and a generative AI model by constructing structured input data, (iii) tags generated responses with explicit source identifiers and reference information, (iv) applies caching of popular information or responses in a high-speed reference storage device, and (v) executes learning processes that update retrieval and inference parameters based on recorded interaction data. Such a technique should improve the technical performance of the computer system itself by reducing response time, improving accuracy and reliability of responses, and enabling scalable operation with optimized use of processing and storage resources.

The specific processing by the specific processing unit 290 of the data processing device 12 in Example 1 is realized by the following means.

The present invention provides a server comprising a processor configured to establish, via a public communication network, a virtual private communication path with a user terminal so as to generate an encrypted communication channel for securely receiving information from the user terminal; to receive, from the user terminal, a search query and a natural language prompt sentence through a search interface and a dialog interface, and to search an information storage device having an index structure for information retrieval based on the search query to acquire related information; to construct input data for a generative AI model that is a natural language processing model based on the prompt sentence and the related information, to request an inference process to the generative AI model, and to generate a dialog-type response sentence; to associate, when generating the response sentence, identification information that identifies an acquisition source of the related information with the response sentence so as to specify an information source, and to transmit reference information for the information source to the user terminal for display; to record past prompt sentences, response sentences, search results, and evaluation information from a user, and to execute a learning process to improve accuracy of future responses by updating, based on the recorded information, at least one of an information acquisition condition, a method of constructing the input data, and an inference condition of the generative AI model; and to identify information or response sentences repeatedly requested by a plurality of users, to store the identified information or response sentences in a high-speed reference storage device, and to shorten response time by reading the information or response sentences from the high-speed reference storage device in response to subsequent requests. This enables an improvement of the computer system itself, including secure and efficient handling of user queries over an encrypted network path, technically optimized cooperation between a retrieval subsystem and a generative AI model through structured prompt construction, reduction of processing load and latency by caching frequently requested information, and adaptive refinement of retrieval and inference behavior based on accumulated interaction data, thereby providing faster, more accurate, and more reliable natural language responses.

The term “public communication network” refers to a communication infrastructure that allows data transmission between geographically dispersed devices over shared physical or logical links, including networks such as the Internet and other wide area networks accessible by multiple users.

The term “virtual private communication path” refers to a logically isolated communication channel established over a public communication network, in which data packets are encapsulated and routed so that they appear to be transmitted within a private network.

The term “encrypted communication channel” refers to a communication path in which data transmitted between endpoints is transformed using cryptographic algorithms so that the data is unintelligible to unauthorized entities.

The term “user terminal” refers to an information processing device operated by a user, such as a computer, a mobile device, or another electronic apparatus capable of executing an application and communicating with a server.

The term “search interface” refers to a user interface component that allows a user to input a search query and to receive and display search results.

The term “dialog interface” refers to a user interface component that allows a user and a system to exchange messages in a conversational manner, typically using natural language text.

The term “search query” refers to a set of one or more terms, phrases, or expressions provided by a user or an application to specify a request for retrieval of information.

The term “natural language prompt sentence” refers to a text string in a human language that is provided as an input to a natural language processing model to specify a task, a question, or instructions.

The term “information storage device” refers to a storage component or subsystem, such as a memory device or a storage system, that stores data, documents, or records for later retrieval.

The term “index structure” refers to a data structure associated with an information storage device, configured to organize and reference stored data in a manner that supports efficient searching and retrieval.

The term “related information” refers to information retrieved from an information storage device that is determined to be relevant to a received search query or prompt sentence according to a retrieval or ranking process.

The term “input data for a generative AI model” refers to a structured representation of one or more prompt sentences and associated context information that is formatted to be processed by a generative artificial intelligence model.

The term “generative AI model” refers to a computational model, such as a neural network-based natural language processing model, that is configured to generate output data, including natural language text, in response to input data.

The term “natural language processing model” refers to an information processing model designed to analyze, interpret, and generate text or other representations in human languages.

The term “inference process” refers to a computational procedure in which a trained model, such as a generative AI model, receives input data and produces corresponding output data without modifying its learned parameters.

The term “dialog-type response sentence” refers to a natural language text output that is formatted as a response in a conversational exchange between a system and a user.

The term “identification information” refers to data that uniquely or distinctly indicates an origin, type, or location of other data, such as an identifier of an information source.

The term “acquisition source” refers to an origin or location from which related information is obtained, such as a particular data store, document, or service.

The term “information source” refers to a repository, document, record, or service from which information used in generating a response is derived.

The term “reference information” refers to metadata or linkage data, such as a title, identifier, or access path, that allows a user or a system to locate or verify an information source.

The term “prompt sentence” refers to a natural language expression provided to a model or system to specify a query, an instruction, or a context for generating a response.

The term “response sentence” refers to a natural language expression generated by a system or model in reply to a prompt sentence or query.

The term “search result” refers to an item or set of items identified by a retrieval process as relevant to a received search query.

The term “evaluation information” refers to data indicating an assessment of system behavior or output, including explicit user feedback, ratings, or other quality indicators.

The term “learning process” refers to a computational procedure in which recorded data is analyzed to update one or more parameters, rules, or conditions governing system behavior so as to improve performance over time.

The term “information acquisition condition” refers to one or more parameters, rules, or criteria that control how and from where information is retrieved, including query formulation rules and filtering conditions.

The term “method of constructing the input data” refers to procedures and rules for selecting, ordering, formatting, and combining prompt sentences and related information to form input data for a generative AI model.

The term “inference condition of the generative AI model” refers to one or more parameters or settings that govern how the generative AI model performs inference, including but not limited to maximum output length, sampling strategy, and control instructions.

The term “information or response sentences repeatedly requested” refers to information items or generated replies that are requested or produced multiple times across different user interactions within a system.

The term “high-speed reference storage device” refers to a storage component, such as a memory device or cache system, configured to provide faster access to stored data than a primary storage device.

The term “subsequent requests” refers to requests for information or responses that occur after an initial request and that are the same as, or similar to, the initial request according to predetermined criteria.

The term “extended prompt sentence” refers to a natural language prompt sentence that has been augmented with selected related information to provide additional context to a generative AI model.

The term “importance” refers to a measure or score indicating relative usefulness or relevance of a piece of information for constructing input data or generating an accurate response.

The term “classification result” refers to an outcome produced by a classification process that assigns recorded prompt sentences or response sentences to one or more categories or classes.

The term “weighting parameter of the index structure” refers to a numerical or logical value used to control the contribution of indexing features, such as terms or fields, when computing relevance scores during information retrieval.

The term “control parameter for the generative AI model” refers to a setting or value that influences the operation of a generative AI model during inference, including parameters related to decoding, constraints, or stylistic behavior.

The term “information retrieval process” refers to a sequence of operations in which the system interprets a query, accesses an index structure, identifies candidate items, and outputs search results.

The term “response generation process” refers to a sequence of operations in which the system prepares input data for a generative AI model, invokes the model, and post-processes the generated output into a response sentence.

In one embodiment, a server, a terminal, and a user cooperate to implement the claimed system. The server includes at least one processor, a main memory, a non-volatile storage device, a network interface, and, in some embodiments, one or more hardware accelerators such as graphics processing units. The terminal includes a processor, a memory, a display device, an input device, and a network interface. The user operates the terminal to access the server over a public communication network.

The server uses a virtual private network software component, such as a generic VPN server program implementing a transport layer security protocol, and the terminal uses a corresponding VPN client program. The server and the terminal thereby establish a virtual private communication path on the public communication network. The server configures a VPN tunnel so that packets between the terminal and the server are encapsulated and encrypted using symmetric encryption, such as an advanced encryption standard cipher, and are authenticated using message authentication codes. By configuring routing tables and firewall rules, the server restricts access to application programming interfaces to packets received through the encrypted communication channel. This arrangement reduces the risk of eavesdropping and tampering and improves security at the network layer and transport layer.

The terminal executes a web browser or a dedicated client application. The terminal downloads, from the server, interface resources such as markup data, style data, and client-side script data. The terminal renders a search interface and a dialog interface on the display device by executing the client-side script. The search interface allows the user to input a search query in text form, for example “remote work policy” or “meeting room usage rules.” The dialog interface allows the user to input a natural language prompt sentence, such as “Tell me the schedule of the next meeting.”, “Summarize the latest remote work policy and highlight any changes from last year.”, or “Explain step by step how to install the VPN client on Windows 11.” The terminal transmits the input text, together with session identifiers and, in some embodiments, selected search results, to the server over the encrypted communication channel.

The server stores enterprise or organizational information in an information storage device. The information storage device may be implemented by a relational database, a document database, a file system, or a combination thereof, running on a mass storage medium such as a magnetic disk device or a solid-state storage device. The server constructs and maintains an index structure for information retrieval over the stored information. The index structure may be implemented by an inverted index, in which the server stores, for each term or token, a posting list containing identifiers of documents in which the term appears. The server assigns weighting parameters to terms and fields so that the server can compute relevance scores based on term frequency and inverse document frequency or other ranking formulas.

The server receives a search query from the terminal and parses the query into tokens. The server normalizes the tokens, for example by lowercasing and stemming. The server then accesses the index structure in the information storage device and retrieves posting lists for the tokens. The server calculates relevance scores for candidate documents, for example by computing a weighted sum over term-specific contributions, and ranks the documents. The server thereby acquires related information associated with the search query. The server generates search results including document identifiers, summary snippets, and metadata such as titles and timestamps, and transmits these search results to the terminal. This retrieval process uses the index structure and weighting parameters to reduce search time and to avoid exhaustive scanning of the information storage device, thereby improving computational efficiency and reducing input/output load.

The server includes a generative AI model implemented as a natural language processing model. In one embodiment, the generative AI model is a transformer-based neural network comprising an embedding layer, a plurality of self-attention layers, and feed-forward layers. The server stores parameters of the generative AI model, including word embedding matrices, attention weight matrices, and layer normalization parameters, in the memory or storage. The server executes a model runtime using a machine learning framework such as a general-purpose tensor computation library, and in some cases offloads matrix multiplication operations and attention computations to a graphics processing unit to improve throughput.

The server constructs input data for the generative AI model based on a prompt sentence received from the terminal and the related information retrieved from the information storage device. The server selects, from among a plurality of pieces of related information, portions having higher importance scores. The server can compute importance scores using criteria such as retrieval relevance rank, recency of the information source, or a learned scoring function that uses features including term overlap with the prompt sentence and document type. The server truncates or summarizes lower-importance information to keep the total token length under a threshold determined by the model's maximum input length parameter. The server then concatenates the prompt sentence and the selected related information into an extended prompt sentence. For example, the server can construct an extended prompt sentence of the form:

“Context: The next meeting is ‘Project Review’ scheduled on March 10 from 3:00 PM to 4:00 PM. Question: Tell me the schedule of the next meeting.”

By explicitly constructing the extended prompt sentence, the server ensures that the generative AI model receives both the user's question and relevant structured context.

The server then converts the extended prompt sentence into model input tokens. The server uses a tokenizer algorithm such as byte pair encoding or a similar subword segmentation algorithm to map the text into integer token identifiers. The server loads the corresponding embedding vectors from an embedding matrix into memory. The server then propagates the embeddings through the transformer layers. In each layer, the server computes scaled dot-product attention scores, applies softmax functions, and computes weighted sums of value vectors. The server then processes the resulting hidden states through feed-forward neural network layers that include linear transformations and non-linear activation functions. The server repeats these operations across a stack of layers according to the model architecture. During inference, the server iteratively predicts next tokens by computing probability distributions over the vocabulary and selecting tokens using a decoding strategy, such as greedy decoding or top-k sampling, subject to decoding parameters like temperature and maximum output length. The server thereby generates a dialog-type response sentence in natural language.

The server associates, during generation or immediately thereafter, identification information for information sources with the generated response sentence. When the server constructs the extended prompt sentence, the server maintains a mapping between segments of context text and identifiers of corresponding information sources, such as document identifiers, database record keys, or calendar event identifiers. The server propagates this mapping into a response metadata structure by tracking which context segments contributed to the generated output. For example, if the server includes a calendar event describing “Project Review” in the context, the server associates a calendar event identifier with that portion of the generated response that mentions the meeting. The server then constructs reference information including human-readable titles and access locations and returns this reference information together with the response sentence to the terminal. This explicit association allows the terminal to display source links, and allows the user to verify the origin of the data, improving transparency and enabling error detection.

The terminal receives the response sentence and associated reference information from the server. The terminal renders the dialog-type response sentence on the dialog interface, and displays, under or near the response, reference elements such as clickable text or icons. When the user selects a reference, the terminal requests the corresponding resource from the server or another backend service and displays the original document or record. For example, when the response sentence includes “The next meeting is tomorrow from 3:00 PM to 4:00 PM,” the terminal may display a link labeled “Calendar entry” that opens a detailed view of the meeting event.

The server records past prompt sentences, response sentences, search results, and evaluation information from the user in a log store or training data repository implemented on a non-volatile storage device. The server defines a data schema for the recorded data, including fields such as a prompt text, a response text, identifiers of retrieved documents, document ranks, timestamps, user identifiers or anonymized IDs, evaluation labels such as “useful” or “not useful,” and other interaction attributes. The server classifies the recorded prompt sentences and response sentences into categories using a classification algorithm, which may be a supervised classifier such as a logistic regression model or a neural network classifier that uses text embeddings as features. The server stores the classification result as an additional field in the recorded data.

The server executes a learning process periodically or on demand. In one embodiment, the server reads logged records and computes statistics such as error rates or dissatisfaction rates for specific query types or document types. The server adjusts the weighting parameters of the index structure based on these statistics, for example by increasing the weight of terms and fields associated with highly rated responses and decreasing the weight of terms and fields associated with low-rated responses. The server also adjusts control parameters for the generative AI model, such as context window size, prompt templates, or decoding parameters, depending on which settings are associated with better evaluation results. By updating these parameters, the server changes, at the computer level, how retrieval and generation operations are performed to improve accuracy and reduce unnecessary computation.

In another embodiment, the server uses the recorded data to fine-tune the generative AI model. The server prepares training examples consisting of prompt sentences or extended prompt sentences as inputs and desired response sentences as outputs. The server defines an error function such as a cross-entropy loss over the predicted token distributions compared to the target token sequences. The server computes gradients of the loss with respect to model parameters using backpropagation, and updates the parameters using an optimization algorithm such as stochastic gradient descent or an adaptive gradient method. The server may perform such fine-tuning on a separate training system, then deploy updated model parameters to the inference system. This process allows the generative AI model to learn patterns specific to the stored information and user behavior, thereby reducing errors and improving the alignment between user expectations and generated responses.

The server identifies information or response sentences that are repeatedly requested by a plurality of users by analyzing the recorded data or online request statistics. The server aggregates counts of identical or similar prompt sentences and maps them to corresponding response sentences or underlying information items. When the server detects that a particular content item or response sentence is requested frequently, the server stores this item in a high-speed reference storage device such as an in-memory cache. The server stores both textual data and structured metadata for the cached entries. When the server receives a subsequent request that matches or closely resembles a cached key, the server bypasses full retrieval and generative model inference and retrieves the response directly from the high-speed storage device. By performing this caching mechanism, the server reduces average response time and reduces computational load on both the storage subsystem and the generative AI model. This is not a mere automation of manual answering; the server uses non-trivial caching policies, similarity metrics, and model-aware cache keys to minimize redundant model invocations and to manage cache memory efficiently.

The terminal and the server jointly support technical improvements beyond human manual processes. The server performs request routing, encryption, retrieval, model inference, logging, learning, and caching using specific data structures and algorithms that exploit the capabilities of the underlying hardware. For example, the server uses the inverted index structure to reduce the complexity of search operations from linear in the number of documents to sub-linear in the index size; the server uses the transformer architecture to perform parallel attention computations across tokens; the server uses hash tables and least-recently-used policies to manage entries in the high-speed reference storage device. These techniques collectively reduce processing time per request, lower latency on the network path, and reduce energy consumption in the data center by avoiding unnecessary repeated computations.

In an alternative embodiment, the server divides the generative AI model into multiple stages, such as a retrieval stage and a reranking stage, and uses separate submodels with different architectures. The server may use a smaller encoder model to generate dense embeddings for documents and queries and to retrieve candidate documents in an approximate nearest neighbor index, then use a larger decoder model to generate the final response sentence based on the top candidates. This multi-stage arrangement improves computational efficiency by reserving the more expensive decoder operations for a reduced set of candidates, thereby lowering overall compute usage while maintaining or improving response accuracy.

In another variation, the server implements rule-based pre-processing in addition to model-based processing. The server analyzes the prompt sentence using pattern matching or syntactic parsing to detect specific intents, such as “next meeting,” “today's schedule,” or “installation procedure.” When such patterns are detected, the server applies specialized retrieval strategies or prompt templates that are optimized for those intents. For instance, when the server recognizes “next meeting,” the server issues a direct query to a scheduling service with a fixed query pattern, which is more efficient than general text retrieval. This non-conventional combination of rule-based and neural network-based processing improves system robustness and reduces unnecessary load on the generative AI model.

The user interacts with the system by entering queries and prompt sentences and by providing evaluation information, such as clicking “useful” or “not useful” buttons associated with responses. The terminal captures this evaluation information and transmits it to the server. The server uses this evaluation data in the learning process as labels for supervised or semi-supervised learning. Over time, this feedback loop causes the system to adapt its behavior in a way that is driven by recorded data and automated parameter adjustment processes, rather than by static manual configuration. The resulting improvements in retrieval precision, generative accuracy, and system responsiveness arise from specific changes in data structures, algorithmic paths, and model parameters, and thus represent technical improvements to the functioning of the computer system itself.

In summary, the server integrates secure network communication, indexed information retrieval, structured prompt construction, transformer-based generative AI inference, explicit source association, adaptive learning, and high-speed caching. The terminal provides user interfaces for search, dialog, and source verification. The user supplies natural language prompt sentences and feedback. Through these components and processing flows, the system provides a concrete implementation that improves processing speed, response accuracy, and data management within the computer environment, rather than merely automating a human workflow.

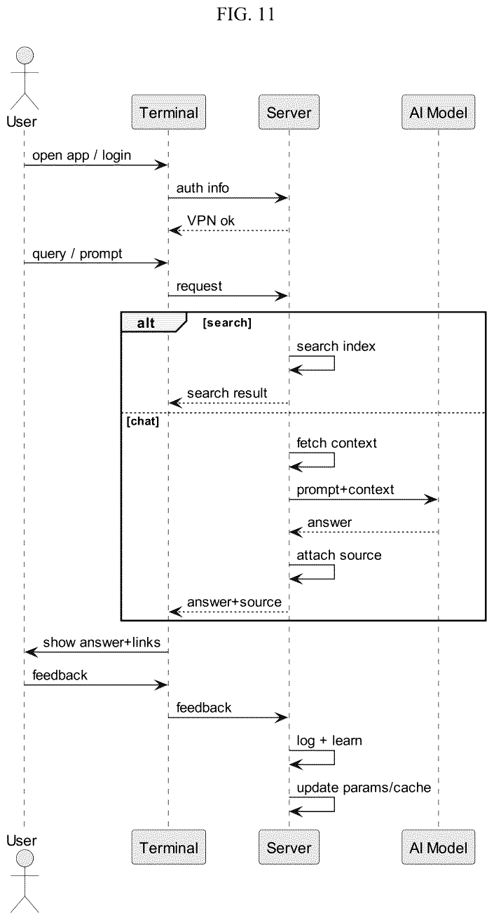

The following describes the processing flow using FIG. 11.

### Step 1

The user starts a client application on the terminal and initiates a connection to the server. The user inputs authentication information such as a user identifier and a secret string into a login screen. The terminal takes the authentication information as input, encapsulates it into a connection request, and outputs the request toward the server over a public communication network.

### Step 2

The server receives the connection request as input and executes a virtual private network handshake. The server verifies the authentication information against an authentication store by performing comparison and lookup operations. The server generates cryptographic keys using a key-exchange algorithm, configures an encrypted communication channel, and outputs a confirmation message and tunnel parameters to the terminal. The terminal receives the tunnel parameters as input, sets routing and encryption states, and outputs subsequent application messages through the encrypted channel.

### Step 3

The user views a search interface and a dialog interface rendered on the terminal. The user inputs a search query, for example “remote work policy,” or inputs a natural language prompt sentence, for example “Tell me the schedule of the next meeting.” as text into the appropriate input field. The terminal takes the user's text as input, attaches session identifiers and timestamps, and outputs a structured request message to the server through the encrypted communication channel.

### Step 4

The server receives the structured request as input and determines whether the request is a search query or a dialog request. When the request is a search query, the server tokenizes the query text into terms, normalizes the terms, and outputs a set of query tokens. The server uses the query tokens as input to an index structure stored in an information storage device, retrieves posting lists, computes relevance scores using weighting parameters and arithmetic operations, ranks candidate documents, and outputs a ranked list of document identifiers with associated metadata as a search result. The server then sends the search result to the terminal. The terminal receives the search result as input and outputs a rendered list of items on the display device.

### Step 5

The server receives, as input, a dialog request containing a prompt sentence and optionally identifiers of related documents selected by the user or obtained from a previous search. The server uses the prompt sentence and the related document identifiers as input to a retrieval process that fetches full document contents or excerpts from the information storage device. The server computes importance scores for each candidate excerpt based on retrieval rank, term overlap with the prompt sentence, and recency, executes numerical comparisons to select higher-scoring excerpts, and outputs a set of selected context segments as related information.

### Step 6

The server constructs extended input data for a generative AI model. The server takes as input the prompt sentence and the selected context segments. The server concatenates these texts using predefined templates, for example by adding a “Context:” section followed by a “Question:” section, and outputs an extended prompt sentence. The server then applies a tokenizer to the extended prompt sentence, converting characters into token identifiers based on a tokenization rule. The server outputs a sequence of tokens representing the extended prompt sentence.

### Step 7

The server feeds the token sequence as input to the generative AI model. The server loads embedding vectors corresponding to each token identifier and outputs an initial embedding matrix. The server then performs matrix multiplications and nonlinear transformations through multiple transformer layers, computing attention weights and applying softmax functions to obtain probability distributions over tokens. Using a decoding algorithm such as greedy decoding or top-k sampling, the server iteratively selects next tokens based on these probability distributions. The server concatenates the selected tokens, converts them back to characters, and outputs a dialog-type response sentence in natural language.

### Step 8

The server associates information source identifiers with the generated response. The server uses, as input, a mapping between context segments and their acquisition sources that was maintained when constructing the extended prompt sentence. The server analyzes the response sentence text, for example by matching phrases from the response against context segments using string comparison or similarity calculation. The server links portions of the response to corresponding source identifiers, constructs reference information including titles and access locations, and outputs a combined structure that includes the response sentence and source references.

### Step 9

The terminal receives the combined structure from the server as input. The terminal parses the structure, extracts the response sentence and the reference information, and outputs a formatted dialog message on the display. The terminal generates interactive elements, such as clickable links or buttons, corresponding to each source reference. When the user selects a reference, the terminal takes the reference identifier as input, sends a request for the underlying document to the server, and outputs the retrieved document on the display device.

### Step 10

The server records interaction data. The server receives, as input, the prompt sentence, the extended prompt sentence, the response sentence, the related document identifiers, and any evaluation information from the user, such as a “useful” or “not useful” selection. The server creates a log record data structure containing these fields, appends timestamps and session identifiers, and performs a write operation to a log store or training data repository. The server outputs updated log storage that accumulates interaction histories.

### Step 11

The server executes a learning process based on the stored logs. The server reads batches of log records as input, extracts features such as term distributions, document ranks, user evaluation labels, and response lengths, and applies statistical analysis or machine learning algorithms. The server computes error metrics, such as misclassification rates or loss values, and adjusts retrieval weighting parameters and model control parameters by applying optimization rules or gradient-based updates. The server outputs updated parameters that are stored in configuration modules or model parameter files and are applied in subsequent retrieval and generation operations, thereby changing the internal behavior of the computer system.

### Step 12

The server performs caching of frequently requested information. The server analyzes log records and live request statistics as input to identify repeated prompt sentences or repeated document accesses. The server applies counting and threshold comparisons to detect items that exceed a frequency criterion, and outputs a list of popular items. The server stores these items, including response sentences and corresponding metadata, in a high-speed reference storage device as cache entries. When the server later receives a new request as input, the server computes a cache key, searches the high-speed storage for a matching entry, and, when a match is found, outputs the cached response directly without executing full retrieval and model inference, thereby reducing processing time and resource usage.

### Step 13

The user interacts with the system in an iterative manner. The user reads the displayed response sentence and optionally inspects the referenced sources. The user then decides whether to provide evaluation information or to input a follow-up prompt sentence, such as “Show only my meetings this afternoon.” The terminal takes the new prompt sentence and evaluation feedback as input, forwards them to the server, and outputs updated dialog content based on the server's new response. Through this iterative loop, the user influences the data that the server uses for learning, and the server increasingly refines retrieval behavior, generative AI model inputs, and caching decisions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional route guidance systems in vehicles, including systems used for autonomous or highly automated driving, have several technical limitations from a computer technology perspective. First, such systems typically execute route computation and guidance generation as a series of loosely coupled processing stages, in which acquisition of map data, traffic data, and weather data is performed separately from natural language interaction with a user. As a result, a computing device is unable to construct a unified, machine-readable representation that jointly captures multiple candidate routes, real-time environmental conditions, and user constraints, and therefore cannot produce context-aware explanations that are both computationally grounded and intelligible to the user.

Second, although generative AI models are known for producing natural language text, conventional systems that incorporate such models generally treat them as post-processing components. The computing device often passes only a user question to the model, without providing structured route evaluation metrics, source information, or safety indicators. This architecture causes the generative AI model to generate responses that are not tightly constrained by the underlying route computation logic, leading to technically problematic behaviors such as hallucinated reasons, inconsistency with actual traffic or weather conditions, and difficulty in verifying the origin and reliability of the information within the computing environment.

Third, traditional navigation architectures do not implement a feedback-driven updating mechanism that closes the loop between (i) low-level route computation modules and (ii) high-level natural language explanation modules. Processing units in such systems typically lack a mechanism to accumulate user evaluations and travel history and to use those data to automatically tune parameters that govern route scoring logic and prompt construction for the generative AI model. As a result, computational resources cannot adapt over time to user preferences or to systematic differences between predicted and actual travel behavior, which reduces the efficiency and robustness of the overall route guidance computation.

Fourth, existing systems do not provide a consistent, machine-enforced association between each generated explanation and the underlying information resources (map, traffic, weather) used to compute the explanation. Information about source identifiers, access paths, and update timestamps is often not bound to the explanatory output at the data structure level. This lack of binding makes it difficult for the processor to implement internal consistency checks and provenance tracking. Consequently, the computing system cannot reliably control or audit how external data sources influence the generative AI model's output, which is a technical deficiency in the design of the information processing pipeline.

Accordingly, there is a need for an improved computer-implemented route guidance architecture in which a processor: (i) securely acquires user position and destination information; (ii) computes and evaluates multiple candidate routes using integrated map, traffic, and weather data; (iii) generates, for a generative AI model, structured prompt sentences that encode quantitative route indicators and source metadata; and (iv) updates route evaluation and prompt-generation parameters in a learning manner based on user feedback and travel history. Such an architecture would improve the functioning of the computer system itself by enabling consistent, explainable, and adaptable route guidance generation that is technically constrained by internal route computation and data provenance management.

The specific processing by the specific processing unit 290 of the data processing device 12 in Application Example 1 is realized by the following means.

The present invention provides a server comprising a processor and at least one memory storing instructions, wherein the processor is configured to execute the instructions to use a virtual private network connection to securely receive, from a user terminal, user information including position information and destination information; to acquire, from at least one route guidance information processing resource, a plurality of route information items based on the position information and the destination information; to acquire, from at least one external information providing resource, traffic information and weather information corresponding to the plurality of route information items and to associate and integrate the traffic information and the weather information with each of the plurality of route information items; to calculate, for each of the plurality of route information items, at least one time indicator and at least one safety indicator based on the integrated information and to evaluate and rank the plurality of route information items based on the at least one time indicator and the at least one safety indicator; to receive, from the user terminal, a natural language inquiry sentence and analyze the natural language inquiry sentence to extract at least one user intention and at least one constraint condition; to generate, based on the evaluated and ranked route information items and the at least one user intention and the at least one constraint condition, a prompt sentence to be input to a generative AI model, the prompt sentence describing the at least one time indicator and the at least one safety indicator in a comparable format and including summaries of traffic conditions and weather conditions for each route; to transmit the prompt sentence to the generative AI model and obtain, from the generative AI model, a response sentence including at least route selection reasons and guidance content; to acquire identification information, link information, and update time information regarding at least one map information resource, at least one traffic information resource, and at least one weather information resource used in generation of the plurality of route information items, and to generate presentation information associated with the response sentence using the identification information, the link information, and the update time information; to transmit, to the user terminal, guidance information including the response sentence and the presentation information; and to accumulate evaluation information of the user regarding the guidance information and travel history information and to update, in a learning manner, at least one parameter related to the evaluation and ranking of the plurality of route information items and at least one parameter related to generation of the prompt sentence based on the accumulated evaluation information and travel history information. This enables an integrated computing pipeline in which route computation, environmental data fusion, generative AI interaction, information provenance management, and feedback-driven parameter adaptation are coherently implemented within the server, thereby improving the technical functioning of the route guidance system, increasing consistency between computed routes and natural language explanations, and enhancing the ability of the system to adapt over time to real-world travel behavior and user preferences.

The term “system” refers to a combination of hardware components and software components that cooperate to perform route guidance processing, information integration, and natural language interaction as described herein.

The term “processor” refers to one or more processing units, such as a central processing unit or a graphics processing unit, configured to execute instructions stored in at least one memory to perform the functions described in the claims.

The term “memory” refers to one or more non-transitory computer-readable storage media, such as semiconductor memory, magnetic storage, or optical storage, configured to store instructions and data for use by the processor.

The term “user terminal” refers to an information processing device, such as a portable communication device, an in-vehicle device, or a workstation, operated by a user and configured to communicate with the server via a communication network.

The term “virtual private network connection” refers to a logical communication channel established over a public or shared network, in which encryption and tunneling protocols are used to securely transmit data between the user terminal and the server.

The term “user information” refers to data received from the user terminal, including at least position information indicating a location of the user and destination information indicating a target location for route guidance.

The term “position information” refers to data indicating a geographical location, such as coordinates defined by latitude and longitude or similar location identifiers.

The term “destination information” refers to data indicating a target place for travel, such as a geographic coordinate, an address, or a place name.

The term “route guidance information processing resource” refers to a computing resource, such as a routing engine or navigation service, configured to compute route information between an origin and a destination based on map data and route calculation algorithms.

The term “route information item” refers to data defining a candidate travel path between an origin and a destination, including at least a sequence of segments, a distance, and an estimated travel time.

The term “external information providing resource” refers to a data providing system outside the server, such as a traffic information service or a weather information service, that supplies environmental information related to road conditions or weather conditions.

The term “traffic information” refers to data describing a state of traffic for one or more road segments, including at least congestion level, predicted delay, incident information, or road closures.

The term “weather information” refers to data describing meteorological conditions along a route or in a region, including at least precipitation, temperature, visibility, wind, or weather warnings.

The term “integrated information” refers to a combined data structure in which route information items are associated with corresponding traffic information and weather information on a per-segment or per-route basis.

The term “time indicator” refers to a quantitative measure related to travel time for a route, such as an estimated total travel time, an adjusted travel time that accounts for traffic and weather, or a normalized time score.

The term “safety indicator” refers to a quantitative measure representing a risk level for a route, based on factors such as weather severity, road characteristics, historical incident data, or congestion patterns.

The term “evaluate and rank” refers to processing in which route information items are assigned scores or priorities based on time indicators, safety indicators, or other criteria, and are ordered according to the scores or priorities.

The term “natural language inquiry sentence” refers to a sequence of words expressed in a human language, such as spoken or typed input, through which a user requests information or guidance from the system.

The term “user intention” refers to information representing a purpose or goal of the user inferred from the natural language inquiry sentence, such as a request for the fastest route, the safest route, or additional explanation.

The term “constraint condition” refers to a limitation or preference expressed or implied in the natural language inquiry sentence, such as avoiding toll roads, prioritizing safety, limiting travel time, or avoiding specific areas.

The term “prompt sentence” refers to a textual input constructed for a generative AI model, the textual input including structured information describing route characteristics, indicators, and conditions, and instructions regarding how the generative AI model should generate a response.

The term “generative AI model” refers to a machine learning model configured to generate natural language text or other content in response to an input prompt, based on parameters learned from training data.

The term “response sentence” refers to natural language output generated by the generative AI model, the natural language output including at least reasons for selecting a route and guidance content to be provided to the user.

The term “map information resource” refers to a data source including geographic map data such as road networks, points of interest, and geographic features used for route calculation.

The term “traffic information resource” refers to a data source providing traffic information used to characterize or update route conditions.

The term “weather information resource” refers to a data source providing weather information used to characterize or update route conditions.

The term “identification information” refers to data that uniquely or distinctively identifies an information resource, such as a resource name, an identifier string, or a reference code.

The term “link information” refers to data that enables access to an information resource, such as a network address, a uniform resource locator, or an endpoint identifier.

The term “update time information” refers to data indicating a time at which an information resource was last updated or a time at which relevant data were retrieved from the information resource.

The term “presentation information” refers to data prepared for presentation to the user, including at least a representation of source information, such as identification information, link information, and update time information associated with the response sentence.

The term “guidance information” refers to data transmitted to the user terminal that includes at least the response sentence and the presentation information, and may further include route geometry, instructions, and indicators.

The term “evaluation information” refers to data representing a user's assessment of the guidance information, such as ratings, feedback comments, or indicators of user satisfaction or dissatisfaction.

The term “travel history information” refers to data describing past travel behavior of the user or a vehicle, including actual routes taken, actual travel times, deviations from suggested routes, and related contextual information.

The term “parameter related to the evaluation and ranking of the plurality of route information items” refers to a configurable value used by the processor to compute scores or priorities for route information items, including at least weight values assigned to time indicators, safety indicators, or other route attributes.

The term “parameter related to generation of the prompt sentence” refers to a configurable value used by the processor to control content, structure, expression style, or level of detail of the prompt sentence provided to the generative AI model.

The term “update in a learning manner” refers to a process in which the processor adjusts one or more parameters based on accumulated evaluation information and travel history information, using algorithmic techniques such as statistical modeling, machine learning, or optimization, so that future computations or generated outputs are improved over time.

In one embodiment, a server cooperates with at least one terminal to provide context-aware route guidance and explanation using a generative AI model. The server includes at least one processor and at least one non-transitory memory. The terminal includes at least one processor, a display, a communication interface, and optionally a microphone and a loudspeaker. A user operates the terminal in a vehicle, such as an autonomous or highly automated vehicle, to request navigation guidance.

The server uses a virtual private network (VPN) connection between the terminal and the server to securely receive user information. The VPN may be implemented using a tunneling protocol such as IPsec or TLS-based tunneling. The terminal encapsulates request data, including user position information and destination information, in encrypted packets. The server decapsulates and decrypts the packets using a VPN gateway module implemented in software, for example in an operating system such as Linux with a VPN daemon. This configuration reduces the risk of interception or tampering with navigation-related data in transit and thus improves the reliability of the route guidance computation.

The server stores instructions in the memory to implement multiple cooperating software modules. In one embodiment, the server uses a web application framework, such as a Python-based framework or a Java-based framework, to implement an application programming interface (API) that receives position information and destination information from the terminal. The server stores the received information in a structured database, such as a relational database management system. The server represents each navigation request as a record including fields for a user identifier, a timestamp, latitude and longitude of the user's current position, an encoded representation of a destination (coordinate, address, or place name), and optional user preference flags.

The server uses a route guidance information processing resource to acquire multiple route information items. In one embodiment, the server calls a routing engine deployed on the same server or on a separate machine. The routing engine uses a map database in which a road network is represented as a directed graph, with nodes corresponding to intersections and edges corresponding to road segments. Each edge record includes attributes such as length, nominal speed, lane count, and road type. The routing engine uses a shortest path algorithm, such as a variant of Dijkstra's algorithm or the A* algorithm with a heuristic based on geographic distance, to compute candidate routes between the user position and the destination. The server receives, for each route information item, a sequence of segment identifiers, a base travel time estimate, and a base distance.

The server uses external information providing resources to acquire traffic information and weather information. In one embodiment, the server queries a traffic information service via HTTP or HTTPS to obtain congestion levels, accident reports, and road closures, indexed by segment identifiers or by geographic coordinates. The server also queries a weather information service to obtain weather conditions for geographic regions that overlap the computed routes. The server stores traffic information and weather information in dedicated tables in the database, linking them to route segments by segment identifiers or by spatial joins using a geospatial extension such as PostGIS.

The server integrates route information with traffic information and weather information to form integrated information. In one embodiment, the server constructs, in memory, a data structure for each route that contains an ordered list of segments, and for each segment, a base time, a congestion factor, a weather factor, and other attributes. The server calculates, for each segment, an adjusted travel time by multiplying the base time by a congestion multiplier and a weather multiplier, where such multipliers are stored in configuration tables and may depend on congestion categories (free, moderate, heavy) and weather categories (clear, light rain, heavy rain, snow). The server then sums the adjusted times along each route to generate a time indicator for that route.

The server calculates a safety indicator for each route based on safety-related attributes and learned risk models. The server may assign base risk scores to segments according to parameters such as road type, accident frequency, curvature, grade, and visibility categories derived from weather information. The server can implement a risk model using a machine learning library, such as a gradient boosting model or a feed-forward neural network, trained on historical travel data and incident data. In one embodiment, the risk model input features include segment-level attributes (speed limit, lane count, lighting condition), dynamic attributes (current congestion level, current precipitation intensity), and aggregated route-level attributes (percentage of highway, total length in heavy rain, number of complex intersections). The risk model outputs a normalized risk score for each route, which the server stores as the safety indicator.

The server evaluates and ranks the plurality of route information items based on the time indicator and the safety indicator. The server uses an evaluation function that computes a composite score for each route as a weighted sum or nonlinear combination of normalized time and normalized risk, where weight values are parameters stored in the memory. The server may use different parameter sets for different user preference profiles, for example giving more weight to safety for a conservative user profile. The server sorts the route information items by composite score and selects one or more recommended routes. This ranking step ensures that subsequent processing by the generative AI model is constrained to technically valid route candidates that are consistent with the underlying routing, traffic, and weather computations.

The terminal receives natural language input from the user, either via text or via speech. The terminal uses a speech-to-text module, such as a speech recognition library provided by an operating system or a cloud speech recognition service, to convert audio signals from the microphone into a text string. The terminal transmits the natural language inquiry sentence to the server over the VPN connection together with context information such as the currently selected route identifier and the latest estimated arrival time.

The server analyzes the natural language inquiry sentence to extract user intentions and constraint conditions. The server may use a natural language processing (NLP) component implemented with a neural network-based classifier or a sequence labeling model, such as a transformer-based model fine-tuned for intent classification and entity recognition. Input tokens to this model may be constructed by tokenizing the sentence into subword units and embedding them into a vector space using pre-trained embeddings. The classifier outputs an intent label, such as “request_fastest_route_explanation” or “request_safer_route,” and the sequence labeler extracts constraint expressions, such as “even if it is a bit slower” or “avoid toll roads.” The server converts these outputs into a structured representation, for example an internal object containing fields for intent type and a list of constraint flags.

The server generates a prompt sentence for a generative AI model based on the evaluated and ranked route information items and the extracted user intentions and constraint conditions. The server uses a prompt construction module that takes as input the selected route candidates, their time indicators, safety indicators, key traffic and weather summaries, and the intent/constraint structure. The module formats this information into a natural language text that explicitly encodes quantitative indicators and source-based constraints. For example, the server may generate a prompt sentence as follows:

“You are a route guidance assistant for an autonomous vehicle.

User question: ‘Is there a safer route to Tokyo Station, even if it is a bit slower?’

Current location: 35.6900, 139.7000.

Destination: 35.6812, 139.7671 (Tokyo Station).

Route A: 30 minutes, heavy rain on 5 km, two recent accident reports, narrow roads in the last 3 km, risk_score=0.7.

Route B: 36 minutes, light rain on 1 km, no current accidents, wide main roads, risk_score=0.3.

Choose the safest route considering rain and accidents. Explain clearly in simple English why you recommend this route. Mention that it may take longer but improves safety.

Answer in 2-4 sentences.”

In another example, the server may generate a prompt sentence tailored to a fastest-route explanation:

“You are a route guidance assistant for an autonomous vehicle.

User question: ‘Please tell me the best route to Tokyo Station considering traffic and weather.’

Current location: 35.6900, 139.7000.

Destination: 35.6812, 139.7671 (Tokyo Station).

Route A: 28 minutes, moderate traffic, no rain.

Route B: 25 minutes, heavy traffic on 4 km, light rain on 2 km.

Select the route that provides the best balance between short travel time and stable driving conditions. Explain in 2-3 sentences which route you recommend and the main reasons based on traffic and weather.”

The server transmits the prompt sentence to the generative AI model. In one embodiment, the generative AI model is implemented as a large-scale neural network, such as a transformer-based language model, hosted on a separate computing infrastructure. The server sends the prompt via an application programming interface using an HTTP-based protocol. The generative AI model receives the prompt, encodes the prompt tokens using multiple layers of self-attention and feed-forward networks, and generates a response sentence token-by-token using probabilistic sampling constrained by the model's learned parameters.

The server does not treat the generative AI model as an uncontrolled component. Instead, the server constrains the model by providing structured indicators, route summaries, and explicit instructions within the prompt sentence. This constraint ensures that the generated explanation is grounded in the computed route data and environmental information rather than relying solely on statistical patterns. The server receives the response sentence from the generative AI model and stores both the prompt and response in an AI interaction log together with the route identifiers and source metadata.

The server acquires identification information, link information, and update time information for each map information resource, traffic information resource, and weather information resource used in generating the route information. The server maintains a source registry table in the database in which each resource is associated with a resource identifier, a human-readable name, an access URL or endpoint identifier, and the last update timestamp. When the server computes or updates route information, it records, for each route segment or route, the identifiers of the information resources used. The server then generates presentation information that binds the response sentence to the underlying sources. For example, the presentation information may state that traffic data were obtained from a specified traffic service at a specified time, and weather data were obtained from a specified weather service at another time. This binding enables technical functions such as automated consistency checking across sources and improved auditing of system behavior.

The server transmits guidance information to the terminal. The guidance information includes the response sentence, the presentation information, and structured route guidance data such as route geometry and turn-by-turn instructions. The terminal renders the route on a display using a map rendering library and displays the natural language explanation. The terminal also uses a text-to-speech engine to output the explanation through a loudspeaker. This integration of visual and audio guidance contributes to safer operation of the vehicle by reducing the need for the user to manually inspect complex lists of instructions.

The user can provide evaluation information about the guidance information. For example, the user may select a satisfaction level or provide short feedback text such as “The safety explanation was helpful” or “The actual travel time was longer than predicted.” The terminal sends the evaluation information and travel history information, including the actual route taken and actual travel time measured by a positioning module in the vehicle, to the server.

The server accumulates evaluation information and travel history information and updates parameters in a learning manner. In one embodiment, the server uses a supervised learning framework to adjust weights in the route evaluation function. The server may define a loss function that measures the discrepancy between predicted travel times and actual travel times, and between subjective safety scores and user satisfaction ratings. The server performs gradient-based optimization to update model parameters stored in the memory. Similarly, the server can optimize parameters controlling prompt generation, such as the level of numerical detail, the ordering of information, and the explicitness of safety-related explanations. By observing which prompts lead to higher user satisfaction, the server can adjust prompt templates systematically to improve clarity and usefulness.

This learning-based updating of parameters provides a technical improvement over static routing and explanation systems. The server adapts its internal scoring functions, risk models, and prompt construction rules based on objective and subjective feedback. This adaptation reduces prediction errors in travel time, improves alignment between computed safety indicators and user-perceived safety, and increases the efficiency of communication between the server and the user by tailoring explanation length and emphasis.

From the viewpoint of computer technology, the described architecture is not a mere automation of human reasoning. The server defines specific data structures for routes, environmental conditions, and source metadata and uses algorithmic procedures to integrate and evaluate them. The generative AI model is used in a constrained and structured manner: the prompt sentence is generated with explicit time and safety indicators and with explicit references to environmental conditions. The server implements non-conventional processing steps such as (i) binding each generated explanation to underlying data sources at the record level, (ii) feeding quantized performance indicators into the generative AI model via the prompt sentence, and (iii) using user feedback and travel history to jointly update both low-level route evaluation parameters and high-level explanation parameters.

These steps cause technical effects such as reduced inconsistency between route computation and explanation, improved explainability of system behavior, and more efficient use of network and computation resources. For example, by pre-computing and ranking candidate routes and by supplying only essential indicators and summaries to the generative AI model, the server reduces the amount of data that must be transmitted and processed for each explanation, thereby reducing latency and load on both the server and the AI infrastructure. By caching integrated route-environment representations and by structuring prompt sentences, the server can reduce repeated computations for similar queries and re-use intermediate results, leading to faster response times.

The server can be implemented in various alternative configurations. In one alternative embodiment, the route guidance information processing resource is integrated into an in-vehicle computing unit, and the server retrieves pre-computed candidate routes from the vehicle. In another embodiment, the generative AI model is deployed on-premises rather than accessed as a remote service, allowing tighter integration with local security policies and resource scheduling. The server may also use different types of learning models for the risk estimation, such as recurrent neural networks or graph neural networks that directly operate on the road graph structure. The NLP components for intent detection and entity extraction can be implemented as separate models or as a single multi-task neural network.

The terminal may be any computing device capable of secure communication, including a smartphone, a tablet, an integrated head unit, or a wearable device. The user may be a driver, a passenger, a fleet operator, or an external supervisor of an autonomous vehicle. Regardless of specific deployment, the server, the terminal, and the user cooperate so that route computation, environmental data processing, generative AI interaction, and feedback-driven adaptation are realized in a technically integrated manner, thereby enabling the claimed system to achieve the described improvements in speed, accuracy, data management, and explainability of route guidance.

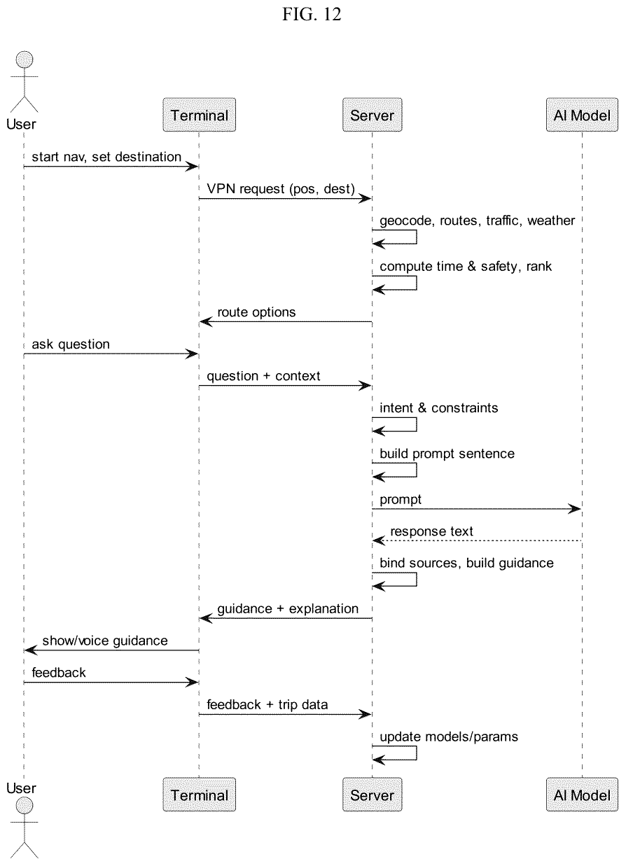

The following describes the processing flow using FIG. 12.

### Step 1

User operates the terminal to start a navigation session and specify a destination.

User inputs a destination by typing a place name or speaking a phrase such as “Take me to Tokyo Station.” The input is the raw textual or spoken destination expression.

Terminal, when receiving speech, converts the audio signal into text using a speech-to-text component and normalizes the text by lowercasing, trimming spaces, and removing obvious noise tokens. The output of this step is a normalized destination text string together with the user's current geographic position obtained from a positioning module.

### Step 2

Terminal transmits the navigation request to the server via a secure connection.

Terminal encapsulates the normalized destination text, current latitude and longitude, and user identifier into a structured message and encrypts the message within a virtual private network tunnel. The input is the normalized destination text and position information; the output is an encrypted data packet sent over the network.

Server receives the encrypted packet, decapsulates it using a VPN module, decrypts its payload, and verifies integrity. The output on the server side is a decoded request object containing user ID, position, destination text, and timestamp.

### Step 3

Server resolves the destination text into geographic coordinates.

Server takes as input the destination text and current position and sends a query to a geocoding resource. The server includes the text and an optional region hint to narrow candidate results. The geocoding resource returns candidate locations with coordinates and confidence scores.

Server performs data processing by ranking candidates according to string similarity, distance from current position, and provider confidence score. The server selects the top candidate and outputs precise destination coordinates (latitude and longitude) and an internal destination identifier.

### Step 4

Server acquires multiple candidate routes between the current position and the destination.

Server uses the current position and destination coordinates as input to a routing engine. The routing engine traverses a road network graph using a path search algorithm, such as A* with a heuristic based on straight-line distance, and generates multiple route candidates that satisfy different optimization criteria (for example, shortest time, shortest distance, fewer transfers).

Server receives, as output, multiple route information items, each including an ordered list of segment identifiers, base travel time, base distance, and basic attributes such as road type distribution. Server stores these route items in a temporary data structure for subsequent processing.

### Step 5

Server acquires traffic information and weather information for the candidate routes.

Server extracts from each route information item the list of segment identifiers or geographic polylines and uses them as input to external information resources. Server sends a traffic query including segment identifiers to a traffic service and receives, as output, congestion levels, delay times, incident flags, and closure indicators per segment.

Server sends a weather query including representative coordinates along the routes to a weather service and receives, as output, weather conditions such as precipitation intensity, visibility, and alerts for each area. The server then associates each segment in the routes with corresponding traffic and weather records by joining on segment ID or by spatial matching of coordinates.

### Step 6

Server integrates route, traffic, and weather information and computes time indicators.

Server takes as input the collection of route segments with their base times and the associated traffic and weather attributes. For each segment, the server performs data computation by calculating a congestion multiplier based on congestion level and a weather multiplier based on precipitation and visibility.

Server multiplies the base segment time by these multipliers to obtain an adjusted segment time. The server then aggregates adjusted times along each route to compute a route-level time indicator such as adjusted total travel time. The output is a set of route records enriched with adjusted time indicators for each route.

### Step 7

Server computes safety indicators for the candidate routes.

Server takes as input route segment attributes (road type, lane count, curvature), dynamic attributes (traffic incidents, closures, heavy rain segments), and historical risk parameters stored in a model. Server applies a risk estimation algorithm, which may be implemented as a neural network or gradient boosting model with weighted features.

Server calculates, for each route, a safety indicator by aggregating segment-level risk scores using a weighted sum or nonlinear combination. The output is an updated set of route records, each including both a time indicator and a safety indicator.

### Step 8

Server evaluates and ranks the candidate routes.

Server uses as input the time indicators, safety indicators, and user preference parameters (for example, safety-prioritizing or time-prioritizing). Server normalizes time and safety values and computes a composite score for each route using a scoring function in which each component is multiplied by a configurable weight.

Server sorts the route records in ascending order of composite score (or descending desirability) and selects one or more top-ranked routes as recommended routes. The output is a ranked list of candidate routes with associated evaluation metrics and identifiers.

### Step 9

Terminal acquires a natural language inquiry from the user about the routes.

User, after seeing or hearing a preliminary route suggestion, speaks or types a question such as “Is there a safer route, even if it is slower?” or “Please tell me the best route considering traffic and weather.” The input is the raw question in speech or text form.

Terminal converts the speech into text if necessary, then packages the question text together with the currently selected route identifier and relevant context (current location, estimated arrival time, selected preference profile) and transmits it securely to the server. The output for the server is a structured inquiry object containing the question text and context.

### Step 10

Server analyzes the natural language inquiry to extract user intention and constraints.

Server takes as input the question text and applies a natural language processing component. The server tokenizes the text, encodes tokens into vectors, and runs an intent classification algorithm to determine the type of request (for example, explanation request, safety-prioritized route request).

Server also runs entity and phrase extraction to detect constraints such as “safer route,” “even if slower,” or “avoid tolls.” The data processing involves mapping extracted words and phrases to a predefined ontology of intents and constraints. The output is a structured representation including an intent label and a list of constraint conditions that guide subsequent processing.

### Step 11

Server prepares a context summary for the generative AI model.

Server uses as input the ranked route list, time indicators, safety indicators, summarized traffic and weather conditions, and the extracted intent and constraints. Server selects the subset of routes that are most relevant to the user's intent (for example, top routes by safety indicator when the intent is a safety-related request).

Server then compresses route attributes into a human-readable summary format: for each considered route, the server selects key numerical values (time, risk score), environmental highlights (presence of heavy rain, number of incidents), and structural features (main roads versus narrow streets). The output is a compact internal context object that can be directly transformed into a prompt sentence.

### Step 12

Server generates a prompt sentence for the generative AI model.

Server takes as input the context object and the user's original question. Server executes a prompt-construction algorithm that arranges the information in a predetermined template. The algorithm inserts the user question, the current location, the destination coordinates, and the summarized description of each route, including explicit time and safety indicators.

Server then adds explicit instructions to the prompt sentence specifying the task, such as “Choose the safest route” or “Balance travel time and stability,” and the desired format and length of the response. The output is a complete prompt sentence, for example:

“You are a route guidance assistant for an autonomous vehicle.

User question: ‘Is there a safer route to Tokyo Station, even if it is a bit slower?’

Current location: 35.6900, 139.7000.

Destination: 35.6812, 139.7671 (Tokyo Station).

Route A: 30 minutes, heavy rain on 5 km, two recent accident reports, narrow roads in the last 3 km, risk_score=0.7.

Route B: 36 minutes, light rain on 1 km, no current accidents, wide main roads, risk_score=0.3.

Choose the safest route considering rain and accidents. Explain clearly in simple English why you recommend this route. Mention that it may take longer but improves safety.

Answer in 2-4 sentences.”

### Step 13

Server transmits the prompt sentence to the generative AI model and receives a response sentence.

Server uses the prompt sentence as input to a generative AI model interface. The server sends the prompt through an API, specifying the model configuration and constraints. The generative AI model processes the prompt by performing internal computations, such as multi-layer self-attention and probability-based token generation, and returns generated text.

Server receives the generated response sentence, parses the returned data structure, and extracts the textual explanation. The output is a natural language explanation that includes at least one recommended route and reasons referencing time and safety conditions.

### Step 14

Server binds the response sentence to information source metadata and constructs guidance information.

Server takes as input the response sentence, the selected route data, and previously recorded source metadata (identification, link, update time) for map, traffic, and weather resources. The server assembles a presentation structure in which each cited traffic or weather condition can be traced back to its originating resource identifier and last update time.

Server combines the response sentence, the selected route geometry, turn-by-turn instructions, and the presentation information into a comprehensive guidance information package. The output is a data object ready to be transmitted to the terminal, ensuring that the explanation remains linked to its technical data sources.

### Step 15

Terminal presents the guidance information to the user.

Terminal receives the guidance information as input. Terminal decodes route geometry and draws the route on a digital map displayed on the screen, and renders turn-by-turn instructions in a list or overlay. Terminal displays the response sentence in a text area so that the user can read the explanation.

Terminal additionally uses a text-to-speech engine to convert the response sentence into audio data and outputs the audio through a loudspeaker. The output is a multimodal presentation in which the user receives both visual and audio guidance synchronized with the route.

### Step 16

User provides feedback on the route and explanation.

User interacts with the terminal interface to rate the guidance, for example by selecting a star rating or choosing options such as “helpful explanation” or “unclear explanation.” User may optionally enter a short comment. The input is the user's evaluation information.

Terminal associates the evaluation with the corresponding navigation session and route identifier, and adds actual travel data such as travel time and deviations observed from the vehicle's positioning information. The output is a structured feedback record transmitted securely to the server.

### Step 17

Server updates internal parameters using accumulated feedback and travel history.

Server takes as input the feedback record and previously stored travel history records. Server executes a learning process in which model parameters for time prediction, safety estimation, and scoring weights are adjusted. This process may involve computing a loss between predicted and actual times or between predicted and user-perceived safety and applying an optimization algorithm to reduce that loss.

Server also analyzes correlations between prompt sentence patterns and user satisfaction levels, and updates prompt-generation parameters to emphasize explanation forms that previously yielded higher satisfaction. The output is a new set of internal parameters stored in memory, which the server applies in subsequent route evaluation and prompt sentence generation, thereby improving accuracy, response quality, and system performance over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional network-based information processing systems that receive user inquiries and route them to appropriate services suffer from several technical limitations. First, when user information is received over general-purpose communication networks, encryption is often applied only at the transport layer without integrated control of end-to-end session context. This leads to fragmented handling of security and session management, and increases the risk of unauthorized access or data leakage when user information is processed across multiple software components.

Second, typical routing and classification mechanisms for user inquiries rely on fixed keyword rules or manually configured decision trees. Such mechanisms are not well suited to unstructured natural language input, and require extensive manual tuning. As a result, these systems cannot robustly extract important terms from diverse expressions, and often misclassify or fail to classify user information, which degrades throughput and reliability of downstream processing.

Third, existing dialog systems that utilize machine learning models usually treat the model as a stand-alone question-answer engine. They do not tightly integrate the model's responses with structured internal information resources, such as structured databases maintained by an organization. Consequently, the system cannot reliably attach explicit source information, such as links to underlying data records, to generated responses. This makes it difficult for a user to verify the origin and reliability of the information, and also prevents the system from programmatically using model outputs as structured inputs for further automated processing.

Fourth, many dialog systems lack persistent management of multi-turn context at the system level. They typically send each user inquiry to a model independently, without combining it with a formal representation of past inquiries and responses. This causes loss of context and requires redundant re-processing of similar information, which leads to inefficiency and inconsistent behavior of the dialog.

Fifth, conventional systems that attempt to analyze user sentiment often perform sentiment analysis separately from the generation process, and do not use the sentiment result to dynamically adjust the control parameters or instruction content (such as prompt sentences) for the generative model. As a result, the system response cannot be effectively adapted to the estimated emotional state of the user, and may remain rigid or inappropriate even when the user state changes.

Further, in many enterprise environments, classification of user information into operational processing units (for example, departments, service queues, or workflow categories) is manually configured and loosely coupled with dialog interfaces. There is no integrated mechanism that uses the same generative model output both to generate natural language responses and to drive automated classification decisions based on extracted important terms. This leads to duplicated logic, increased processing latency, and inconsistent decisions across different subsystems.

Accordingly, there is a technical need for an improved computer-implemented system that: (i) securely receives user information over a virtual private network connection under unified session control, (ii) generates carefully structured prompt sentences for a generative AI model to enable robust extraction of important terms from natural language inquiries, (iii) integrates model responses with structured information resources to automatically attach explicit source information and reference links, (iv) maintains and supplies multi-turn context information to the model for continuous dialog processing, (v) adapts prompt sentences and response expressions based on an estimated emotional state of the user, and (vi) automatically classifies user information into operational processing units using important terms extracted from generative model responses. Such a system can improve the technical functioning of computer-based dialog, classification, and routing infrastructure in networked environments.

The specific processing by the specific processing unit 290 of the data processing device 12 in Example 2 is realized by the following means.

The present invention provides a server comprising a processor configured to establish and maintain a virtual private network connection with a terminal to securely receive user information, to receive a user inquiry expressed in natural language from the terminal and acquire the inquiry as character information, to generate a prompt sentence for use of a generative AI model with respect to the character information and to transmit inquiry data including the prompt sentence and the character information to the generative AI model, to acquire response information from the generative AI model and to refer to structured information stored in an information resource storage device to identify a related information providing source and append source information relating to the information providing source to the response information, to transmit the response information with the appended source information to the terminal via a communication network and cause the terminal to output the response information as display information in a dialog format, to receive from the terminal an additional user inquiry based on the response information and the source information and to execute continuous dialog processing by transmitting to the generative AI model the additional inquiry together with context information including a past inquiry history and the prompt sentence, and to extract important terms from the response information received from the generative AI model and automatically classify the user information into operational processing units based on the important terms. This enables secure, end-to-end controlled reception and processing of natural language user information over a virtual private network, coordinated construction of prompt sentences and context information for a generative AI model, automatic enrichment of generated responses with explicit source information and reference links derived from structured information resources, adaptive multi-turn dialog management that preserves and exploits past inquiry history, and integrated automatic classification of user information into operational processing units based on terms extracted from model responses, thereby improving the technical performance, reliability, and efficiency of computer-based dialog and routing systems.

The term “system” refers to an arrangement of one or more hardware and software components that cooperate to execute the claimed processing, including at least a processor, memory, and communication interfaces.

The term “processor” refers to one or more processing circuits, such as a central processing unit, a microcontroller, a graphics processing unit, or any combination thereof, configured to execute instructions and perform the functions described in the claims.

The term “terminal” refers to an information processing device operated by a user, such as a client computer, a mobile communication device, or another user-end device, that communicates with the server over a communication network.

The term “user information” refers to information provided directly or indirectly by a user via the terminal, including natural language inquiries, input data, and related metadata processed by the system.

The term “virtual private network connection” refers to a logical communication tunnel established over a communication network using encryption and authentication to provide secure, private communication between the terminal and the server.

The term “communication network” refers to any wired or wireless network infrastructure capable of transmitting data between devices, including local area networks, wide area networks, and public packet-switched networks.

The term “user inquiry” refers to an information request expressed by a user, typically in natural language, that is input at the terminal and transmitted to the server for analysis and response.

The term “natural language” refers to a human language, such as a spoken or written language used in everyday communication, as opposed to a formal programming or markup language.

The term “character information” refers to data representing text characters forming the user inquiry or related content, encoded in a suitable character encoding format for processing by the system.

The term “preprocessing” refers to operations performed on character information prior to model input, including at least one of normalization, tokenization, language detection, and removal or transformation of specific characters or patterns.

The term “prompt sentence” refers to an instruction text or control text supplied to a generative AI model, defining a role, behavior, constraint, or context for the model in generating response information.

The term “generative AI model” refers to a machine-learned model capable of generating natural language or other content based on input data and learned parameters, including large language models and similar generative models.

The term “inquiry data” refers to structured data transmitted to the generative AI model, including at least the prompt sentence and the character information representing the user inquiry, and optionally additional context information.

The term “response information” refers to information generated by the generative AI model in response to the inquiry data, including at least natural language text and, optionally, structured output.

The term “information resource storage device” refers to one or more storage systems that store structured information used by the server, such as databases, data repositories, or other structured data storage mechanisms.

The term “structured information” refers to information stored in a predefined data format, such as records in a database table or objects in a data structure, enabling programmatic querying and retrieval.

The term “information providing source” refers to an origin or provider of information, such as a data record, a data collection, or an external or internal information system, from which the system derives or verifies content.

The term “source information” refers to data indicating the information providing source of response information, including identifiers, labels, or links that allow identification or access to the underlying source.

The term “reference link information” refers to link data, such as a uniform resource locator or equivalent reference, that allows a terminal to access or display information provided by an information providing source.

The term “display information in a dialog format” refers to information structured and presented to the user as a sequence of exchanges resembling a conversation, including user messages and system responses.

The term “additional user inquiry” refers to a subsequent inquiry transmitted by the user after receiving response information and source information, often referencing or refining prior content in a multi-turn dialog.

The term “context information” refers to data representing one or more prior user inquiries, prior responses, and related metadata, used together with a current inquiry to maintain continuity in a multi-turn dialog.

The term “past inquiry history” refers to stored records of previous user inquiries and associated responses within a session or across sessions, used to provide context to the generative AI model.

The term “operational processing units” refers to logical or organizational categories for handling user information, such as processing queues, departments, services, workflows, or functional units within an organization.

The term “important terms” refers to words or expressions extracted from response information or user inquiries that have been determined, according to predetermined rules or model outputs, to be significant for classification or routing.

The term “classify the user information” refers to the act of assigning user information to one or more operational processing units or categories based on at least the important terms extracted by the system.

The term “emotional state of the user” refers to an estimated attitude or affective condition of the user, such as satisfaction, frustration, or urgency, inferred from expressions in user inquiries and related content.

The term “analyze expressions” refers to processing text or similar content to detect patterns, features, or indicators, including linguistic cues, that are used to estimate the emotional state or other attributes.

The term “adjust an expression of the response information” refers to modifying wording, tone, style, or content of the response information based on at least one of the prompt sentence and the estimated emotional state.

In one embodiment, a server cooperates with one or more terminals operated by users to implement the claimed system. The server includes a hardware platform such as a rack-mounted computer equipped with at least one central processing unit (CPU), a main memory, a non-volatile storage device, and one or more network interface controllers. For example, the server can employ an x86_64-compatible CPU, a dynamic random-access memory module, a solid-state drive, and a gigabit Ethernet adapter. The server executes an operating system, such as a general-purpose server operating system, and application software including a virtual private network (VPN) server program, a web application framework, a database management system, and client libraries for accessing an external generative AI model via a network.

A terminal includes a client computing device operated by a user, such as a smartphone, a tablet, a notebook computer, or a desktop computer. The terminal contains a processor, a memory, a display device, an input device (for example, a touchscreen or keyboard), and a network interface. The terminal executes a client operating system and application programs including a VPN client, a web browser or native application for dialog display, and communication libraries for exchanging data with the server.

A user operates the terminal to initiate a secure session with the server. The user causes the terminal to launch the VPN client and to send authentication information to the server. The server executes a VPN server process, such as a process implementing IPsec or OpenVPN protocols, and performs cryptographic key exchange, authentication, and tunnel establishment. The server carries out cryptographic operations including symmetric-key encryption and decryption of packet payloads and integrity verification using message authentication codes. By maintaining a virtual private network connection, the server ensures that user information transmitted between the terminal and the server is encapsulated in encrypted data packets, thereby reducing the risk of interception and improving the reliability of higher-layer session identifiers.

The terminal provides a dialog user interface that allows the user to input natural language inquiries. The user enters text in a human language, for example, “Tell me sightseeing spots in Tokyo,” into an input field displayed on the terminal. The terminal converts the graphical input into character information and normalizes the character encoding, for example, into UTF-8. The terminal may further perform preprocessing such as trimming spaces, filtering prohibited characters, and detecting the language. The terminal encapsulates the character information and relevant metadata (such as timestamps and session identifiers) into a structured message, which the terminal transmits to the server through the VPN connection using a transport protocol such as HTTPS.

The server receives the character information and stores it in memory as structured data, such as a record comprising fields for user identifier, session identifier, raw text, identified language, and processing status. The server then constructs a prompt sentence for a generative AI model. In one embodiment, the server maintains a prompt generation module implemented as a software component in the web application framework. The prompt generation module concatenates a system-level instruction string with context information and the current user inquiry. For example, the server can generate the following prompt sentence:

“You are a travel information assistant. Use only the data stored in the internal travel information database as the primary information source. Use that data to generate the optimal answer for the following user question: ‘Tell me sightseeing spots in Tokyo.’”

In another example, the server generates a more constrained prompt sentence:

“Use the internal travel data records to generate the best possible answer to the user's question. Prefer accuracy and provide only information that can be supported by stored records. If necessary, list the internal record identifiers or URLs that correspond to each recommended place.”

The server structures the combination of the prompt sentence, the user's character information, and context information (such as previous inquiries and responses) into an input sequence for a generative AI model. The server then calls an external or internal generative AI model through a model access module. In one embodiment, the generative AI model is implemented as a transformer-based neural network comprising multiple attention layers, feedforward layers, and layer normalization units. The model parameters include matrices of real-valued weights representing attention heads and projection layers, which have been trained on text corpora and optionally fine-tuned on domain-specific records.

The server converts the input sequence into tokens using a tokenizer, which maps characters or subword units to integer indices. The generative AI model maps these indices to embedding vectors and processes them through the transformer architecture. During this process, the model computes self-attention scores between tokens based on learned weight matrices and uses these scores to generate context-aware token representations. The model then applies a feedforward network to each token representation and produces a sequence of hidden states. The model predicts the next output token at each generation step by applying a softmax function over a vocabulary of possible tokens. The model repeats this process iteratively to generate a response sequence until a termination condition is met, such as emission of an end-of-sequence token or reaching a maximum token length.

In one embodiment, the generative AI model is trained using supervised learning and gradient-based optimization. During training, the model receives input-output pairs and computes a loss function, such as a cross-entropy loss between predicted and target tokens. The model backpropagates the error through the transformer layers and updates weight parameters using an optimization algorithm such as stochastic gradient descent or an adaptive variant. Data augmentation techniques, such as synonym replacement or paraphrasing, can be applied to training samples to increase robustness to varied user expression. These details ensure that the model is capable of interpreting diverse user inquiries and producing coherent, context-sensitive responses when deployed in the system.

The server receives the generated response information from the generative AI model as a sequence of tokens, which the server converts back into character information. The server then invokes an entity extraction module that identifies important terms and candidate entity names in the response. This module can employ a combination of rule-based patterns (for example, detection of capitalized words or specific linguistic structures) and machine-learned sequence labeling techniques, such as conditional random fields or neural sequence tagging networks. The server then maps the extracted entity names to structured entries in an information resource storage device, such as a relational database management system.

The server uses a database engine, for example, a relational database system, to store structured information about information providing sources. The database schema may include tables representing locations, categories, identifiers, and URLs. When the server receives the response information, the server issues parameterized queries to the database, such as search queries where the extracted entity names are used as key values. The server retrieves matching records containing identifiers and access paths, such as URLs, to the underlying data sources. The server aggregates these results into a source information structure, which can include labels like “Source: internal travel database,” record identifiers, and reference links.

The server appends the source information to the response information. In one embodiment, the server inserts annotation markers into the response text, such as numerical references, and associates each marker with a specific record in the source information. The server then stores the combined response and source information in a session database for later retrieval and for construction of context information in subsequent interactions. By maintaining this structured association between model-generated text and structured source records, the server improves the traceability and verifiability of information, and enables automated classification and routing that operates on consistent identifiers rather than on uncontrolled free text.

The terminal receives the enriched response from the server and displays it in a dialog format. The terminal renders the response text as one or more dialog bubbles and presents the source information as clickable items or separate sections. When the user selects a source item, the terminal uses a browser component to fetch the referenced resource, such as a web page or a structured data view, over the communication network. The terminal's dialog display is thus tightly integrated with the underlying structured storage, allowing the user to confirm technical details, such as exact addresses or opening times, without disconnection from the secure session.

The server repeatedly uses the stored context information to construct new prompt sentences for subsequent user inquiries. The user may ask a follow-up question, for example, “Which of these spots are suitable for children?” The server concatenates the previous inquiry and answer, the extracted entities, and the new inquiry into a structured context representation. The server then generates a prompt sentence reflecting this context, such as:

“The user previously asked about sightseeing spots in a specific region and received a list including several places. Now the user asks which of these places are suitable for children. Using the internal travel data, refine the answer to indicate which places are suitable for children and explain why.”

By structuring context in this way, the server ensures that the generative AI model uses relevant historical data rather than arbitrary global statistics. This structured approach improves both consistency and computational efficiency, because the server can constrain the context to a limited set of relevant entities and remove redundant information. The result is reduced token length in model input, which decreases processing time and network transfer size, thereby reducing latency and communication load.

The server also computes an estimate of the emotional state of the user by analyzing expressions in user inquiries and in the generated responses. The server can apply a separate sentiment analysis model or an integrated classification head attached to the generative AI model, which takes token-level features from transformer layers and computes sentiment probabilities using an additional dense layer and a softmax function. The server interprets the sentiment probabilities according to thresholds and maps them to categories such as neutral, positive, or negative. The server then modifies the next prompt sentence or response wording in accordance with the estimated emotional state. For example, if the user appears frustrated, the server causes the prompt sentence to instruct the generative model to respond in a more detailed and reassuring manner. This dynamic adjustment yields technical effects including reduced repetition of unsuccessful responses and more efficient convergence to satisfactory information, which in turn reduces the number of dialog turns and overall resource consumption.

The server uses the important terms extracted from the response information to classify user information into operational processing units. The server maintains a classification table mapping combinations of important terms to specific categories, such as different service queues or functional departments in a larger information system. The server can also utilize a machine-learned classifier, such as a neural network or gradient-boosted decision tree, that receives a vector representation of the important terms and outputs a classification score for each category. Feature vectors can be obtained by embedding the important terms with the same or a related embedding model employed for the generative AI model. By basing classification on the generated response, the server can leverage both the explicit content of the underlying structured database and the model's contextual inference capabilities. This approach produces more stable and accurate classification results than conventional keyword-only matching.

The server's architecture decomposes processing into modules responsible for VPN termination, HTTP request handling, prompt generation, model invocation, entity extraction, source resolution, sentiment estimation, classification, and response assembly. Data flows between these modules are realized as typed data structures in memory, such as objects containing fields for text, token sequences, entities, category labels, and source identifiers. This modular structure facilitates parallel execution and pipeline optimization. For example, the server can pre-fetch related structured records while the generative AI model is generating the response, thereby overlapping network and computation and reducing end-to-end latency.

From a technical standpoint, the described system improves computer technology in several ways. By tightly integrating VPN session management with higher-layer dialog context, the server reduces duplicated authentication logic and allows lower-level session identifiers to be reused in application-level state tracking, which increases robustness and reduces error cases related to session mismatch. By generating specialized prompt sentences that include explicit context and constraints, the server shapes the behavior of the generative AI model so that it relies more heavily on structured internal data than on generic statistical patterns. This reduces the rate of erroneous or hallucinated responses and thereby reduces the need for corrective user intervention. Furthermore, by extracting important terms from model outputs and mapping them to structured identifiers, the server converts unstructured dialog results into structured data that downstream components can process efficiently, which is not achievable by simple human reading or manual routing.

The generative AI model and associated classification mechanisms operate under explicit, non-conventional procedures that differ from manual decision-making. The model employs large-scale matrix operations, attention mechanisms, and gradient-based learning, which allow the system to capture long-range dependencies in text and to process sequences far beyond typical human working memory. The classification and sentiment estimation modules use numeric thresholds, vector norms, and probability distributions that are computed from high-dimensional embeddings. These internal operations are not simple encodings of human rules but are optimized for computational efficiency and statistical accuracy across large datasets. As a result, the system is able to process a much higher volume of inquiries with consistent latency and classification precision, improving both throughput and fairness in routing.

In alternative embodiments, the server can host the generative AI model locally rather than invoking a remote service. In such cases, the server includes one or more graphical processing units or dedicated accelerators, and a local model inference engine that executes the transformer network with optimized numerical kernels. The same data structures and prompt sentence construction procedures can be reused, while the hardware acceleration provides further reductions in processing time. In another embodiment, the terminal may perform part of the preprocessing and entity extraction, thereby offloading certain tasks from the server and reducing central processing load.

In still another embodiment, the server can adapt the structure of the prompt sentence based on measured performance metrics, such as response time and classification accuracy. The server can maintain multiple template variants of prompt sentences and select among them using a reinforcement learning strategy that uses historical success rates as rewards. Such adaptive prompt management further improves the computational efficiency and quality of generated responses, demonstrating that the system's design goes beyond mere automation of human tasks and instead optimizes the underlying computational processes.

In summary, the server, the terminal, and the user cooperate within a technically configured environment where secure VPN-based communication, structured prompt sentence generation, transformer-based generative AI processing, structured source integration, sentiment-adaptive response control, and automatic classification based on important terms interact to achieve improved processing speed, higher accuracy of information retrieval and classification, reduced communication overhead, and enhanced manageability of dialog-related data. This configuration enables a person skilled in the art to implement the claimed invention and demonstrates that the invention provides concrete improvements to computer-based dialog and routing technology.

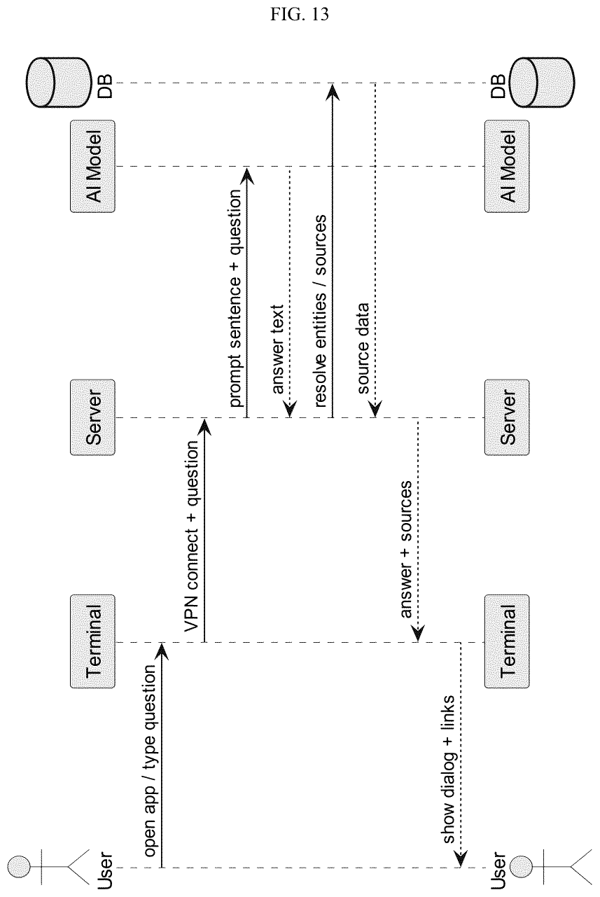

The following describes the processing flow using FIG. 13.

### Step 1

Terminal establishes a secure communication channel with the server.

Terminal launches a VPN client application and prompts the user to input authentication information such as a user identifier and a password.

Input: user credentials (user ID, password, optional token or certificate).

Terminal packages the credentials into a VPN handshake message and sends this message to the server over an underlying network.

Server receives the VPN handshake, validates the credentials against an authentication store (for example, a user table or directory service), and negotiates encryption parameters.

Server performs data operations including key exchange, cipher selection, and assignment of a virtual IP address.

Output: an established VPN tunnel represented by cryptographic session keys and routing rules stored in both the server and the terminal.

Terminal then routes subsequent application-level traffic (for example, HTTPS requests for dialog processing) through the encrypted VPN tunnel.

### Step 2

User initiates a natural language inquiry on the terminal.

User opens a dialog interface on the terminal and types a question such as “Tell me sightseeing spots in Tokyo” into an input field.

Input: raw keystrokes or touch events representing the user's question.

Terminal converts the user interaction into a text string and performs basic preprocessing such as trimming leading and trailing spaces and normalizing character encoding to UTF-8.

Terminal constructs a local data structure including fields for the question text, a timestamp, a session identifier, and a language code.

Output: a structured question object stored in terminal memory, ready to be transmitted to the server.

### Step 3

Terminal sends the structured question to the server through the VPN tunnel.

Terminal serializes the question object into a message format such as JSON and encapsulates it in an HTTPS request.

Input: the structured question object (text, timestamp, session ID, language).

Terminal performs data operations such as JSON encoding, URL construction for an application endpoint, and encryption by passing the request through the VPN and TLS layers.

Server receives the HTTPS request at an application endpoint, terminates TLS, and decapsulates the JSON payload.

Output: a server-side representation of the question data, stored in server memory as a record containing user ID, session ID, question text, and metadata.

### Step 4

Server preprocesses the received question and prepares it for prompt construction.

Server takes the question text and metadata from the server-side record.

Input: server-side question record.

Server performs data operations such as language detection, token counting, and optional filtering of disallowed patterns or sensitive terms.

Server may normalize certain entities (for example, converting full-width characters to half-width or normalizing place names based on an internal dictionary).

Output: a normalized question text and an enriched question record that includes detected language, cleaned text, and flags indicating any preprocessing decisions.

### Step 5

Server constructs a prompt sentence for the generative AI model based on the normalized question and context.

Server retrieves any existing conversation context for the current session, such as previous questions, previous responses, and associated entities.

Input: normalized question text and session context data.

Server executes a prompt generation procedure that concatenates a system role description, data source constraints, and the current inquiry (and, optionally, prior inquiries).

For example, server generates a prompt sentence:

“You are a travel information assistant. Use only the data stored in the internal travel information database as the primary information source. Use that data to generate the optimal answer for the following user question: ‘Tell me sightseeing spots in Tokyo.’”

Server performs string concatenation, template filling, and insertion of context elements such as previously recommended locations.

Output: a prompt sentence string and an input message set consisting of the prompt sentence, the current question text, and context entries.

### Step 6

Server calls the generative AI model with the prompt sentence and question data.

Server constructs an input payload for the generative AI model, including the prompt sentence as an instruction and the user question as content.

Input: prompt sentence and normalized question text (plus context messages).

Server tokenizes the combined text or delegates tokenization to the model service, then serializes the input into an API request.

Server uses an HTTP client to send the request to a model endpoint over HTTPS, adding an authorization token and any required headers.

Data operations include text-to-token mapping, JSON encoding, and secure network transmission.

Output: a pending inference request at the model endpoint and, after processing, a model response containing generated tokens representing the answer text.

### Step 7

Generative AI model generates a natural language answer based on the prompt sentence and question.

Generative AI model receives the tokenized input sequence representing the prompt sentence, question, and context.

Input: token sequence including instruction tokens and question tokens.

The model computes embedding vectors for each token and passes these vectors through multiple transformer layers. In each layer, the model calculates attention weights between tokens, applies weighted sums to produce context-aware representations, and processes these representations through feedforward sub-networks.

The model uses a trained parameter set obtained by minimizing a loss function such as cross-entropy over a training corpus. During inference, the model iteratively predicts the next token by computing a probability distribution over the vocabulary and selecting the most likely token or sampling according to a decoding strategy.

Output: a sequence of output tokens that, when decoded, form a response such as “Popular sightseeing spots in Tokyo include Tokyo Tower, Senso-ji Temple in Asakusa, and Meiji Shrine near Harajuku.”

### Step 8

Server receives the model's generated answer and converts it into text.

Server obtains the API response from the generative AI model endpoint.

Input: model output payload containing a sequence of tokens or already decoded text.

Server performs JSON parsing, token-to-text decoding (if tokens are returned), and normalization of line breaks and special characters.

Server stores the resulting answer text in a response record associated with the current session and question.

Output: a server-side response record that contains the answer text and references to the session and question identifiers.

### Step 9

Server extracts important terms and candidate entities from the answer text.

Server loads the answer text from the response record.

Input: answer text generated by the generative AI model.

Server uses an entity extraction module, which may include rule-based patterns (such as regular expressions for proper nouns) and a trained sequence labeling model, to scan the text and identify important terms like place names, categories, or key attributes.

Server performs data operations including tokenization of the answer text, tagging of each token with part-of-speech or entity labels, and selection of tokens labeled as important entities.

Output: a list of important terms and associated metadata (positions in text, entity types) stored in an entity list structure.

### Step 10

Server resolves extracted entities against an information resource storage device to identify information providing sources.

Server takes the list of important terms and constructs database queries to a structured storage, such as a relational database containing travel records.

Input: list of important terms and a database of structured records.

Server executes queries that match terms against stored fields (for example, location names or aliases) and retrieves corresponding records, including identifiers and URLs.

Server performs data processing such as string comparison, fuzzy matching, and ranking of candidate records based on similarity scores.

Output: a resolved source list containing, for each important term, one or more matched records with standardized identifiers and reference links.

### Step 11

Server generates source information and reference link information to append to the answer.

Server uses the resolved source list to construct a source information structure.

Input: resolved source list and answer text.

Server builds data entries including a general label such as “Source: internal travel database,” per-entity names, descriptions, and URLs.

Server may insert inline markers into the answer text (for example, “[1]”, “[2]”) and associate each marker with a specific source entry.

Data operations include mapping from entity positions to markers, assembling structured arrays of link data, and merging this structure with the response record.

Output: an enriched response object containing the original answer text, annotation markers, and compiled source information with reference link information.

### Step 12

Server classifies the user information into operational processing units based on the important terms.

Server takes the list of important terms, their mapped source records, and possibly additional features such as detected categories or sentiment scores.

Input: important terms, entity types, and context attributes.

Server applies a classification algorithm, which can be implemented as a rule engine (mapping certain combinations of terms to categories) or as a machine-learned classifier that receives a feature vector derived from embeddings of the terms.

Server calculates scores for each candidate operational processing unit and selects one or more units that meet selection criteria such as highest score or threshold-based confidence.

Output: classification results indicating which operational processing units should handle the user information, stored as part of the session or routing metadata.

### Step 13

Server prepares the final response payload for the terminal.

Server reads the enriched response object and the classification results.

Input: enriched response object (answer text plus source information) and classification metadata.

Server composes a response message structure including the answer text, structured list of sources and links, and possibly classification labels for internal use.

Server serializes this structure into a transport format and attaches HTTP headers or status codes indicating success.

Output: a formatted response message ready to be transmitted over HTTPS through the VPN tunnel to the terminal.

### Step 14

Terminal receives and displays the enriched response in a dialog format.

Terminal obtains the response message from the server via HTTPS and decodes the payload.

Input: formatted response message containing answer text and source information.

Terminal parses the JSON or equivalent structure and extracts display elements such as the answer text and a list of link entries.

Terminal renders the answer text as dialog bubbles on the display and generates UI components such as buttons or list items for each reference link.

Output: a visual dialog view in which the user can read the answer and interact with source links.

### Step 15

User reviews the answer and optionally accesses source links or submits a follow-up inquiry.

User reads the displayed answer and may tap or click on source links to open detailed information in a browser component on the terminal.

Input: visual elements representing answer text and links.

Terminal reacts to user operations by launching an embedded browser or external browser, sending HTTP requests to the referenced URLs, and displaying the returned content.

User may then type a new, follow-up inquiry such as “Which of these spots are suitable for children?” into the same dialog interface.

Output: either additional web content from the sources or a new question text ready for transmission, which re-enters the flow at the earlier steps for prompt construction and model invocation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that use natural language interfaces and network connections suffer from several technical limitations that degrade overall system performance and reliability. First, when user input is received over a network, the system typically treats the input as a simple text string and processes it with fixed rules. As a result, the system cannot dynamically adapt its processing pipeline to the actual user intention, and computational resources are wasted on irrelevant modules, causing unnecessary latency and increased processor load. Second, existing systems often perform intent detection, routing of the request to internal modules, and response generation as isolated functions. This fragmented architecture leads to duplicated processing, inconsistent internal state, and higher memory consumption, which in turn reduces throughput and scalability of the system under high traffic.

Further, many systems do not integrate real-time emotion analysis into the core control flow of the processor. Emotion analysis, if present, is often applied only at a user-interface layer and does not influence how the backend selects operations, constructs prompts for machine learning models, or allocates resources. This separation prevents the system from optimizing responses and processing paths according to user state, leading to inefficient use of generative models, redundant network calls, and longer end-to-end response times.

Moreover, conventional systems that use generative AI models typically send simple, unstructured prompts and then attempt to repair or post-process the model output. Such designs fail to exploit the model as a unified engine for intent extraction, keyword extraction, and dialog generation. As a consequence, external rule engines or multiple classifiers must be maintained and executed in addition to the generative model, increasing complexity, memory usage, and latency. This also makes it difficult to adapt the system behavior based on accumulated operational data, because learning signals are not captured in a way that can be systematically fed back into the control logic.

In addition, conventional architectures do not tightly couple secure network reception (for example, via a virtual private network), source reliability evaluation, and learning-based updates of internal parameters. Information retrieved from external sources is often used without structured metadata such as source position, reference links, and reliability indicators, which complicates automated consistency checks and trust evaluation. This leads to increased risk of propagating inconsistent or low-quality information, and forces human operators or separate verification modules to be involved, which again increases processing time and resource consumption.

Accordingly, there is a need for an improved computer-implemented system in which a processor securely acquires user information, uses generative AI models through carefully constructed prompt sentences to unify intent extraction, keyword extraction, and dialog generation, automatically routes information to internal functional modules, performs emotion-aware response generation, and continuously updates internal models and control parameters based on logged learning data. Such a system should improve the efficiency and reliability of the entire processing pipeline, reduce latency, reduce redundant computation, and enhance scalability in multi-user, networked environments.

The specific processing by the specific processing unit 290 of the data processing device 12 in Application Example 2 is realized by the following means.

The present invention provides a server comprising a processor configured to establish a communication path using a virtual private network connection in order to securely receive information from a user terminal, to convert voice input provided by a user into character information and generate a prompt sentence, to generate, using the prompt sentence as input, an analysis prompt sentence for a generative AI model and to use the generative AI model to extract a user intention and important terms, to automatically classify the received information into a predetermined functional module or business division based on the important terms and the user intention, to select at least one processing operation among a route guidance operation, an information retrieval operation, and a support operation according to the user intention and to execute the selected processing operation using stored data including geographic information data, traffic information data, or business information data, to perform communication with an external information source and, for acquired external information, to add source position information, a reference link, and a reliability indicator and verify consistency of the acquired external information, to perform emotion analysis using character information or voice information received from the user and identify an emotion type and an emotion intensity, to generate a response-generation prompt sentence in which the emotion type and the emotion intensity are taken into account and to use the generative AI model to generate dialog-type response information, and to store the generated response information, a classification result, a processing result, and information regarding the information source as learning data and update at least one of an analysis model and a control parameter so as to improve subsequent processing and response generation. This enables integration of secure network-level reception, intent-based routing, emotion-aware prompt construction, and learning-based parameter updating into a single coordinated processing pipeline, thereby reducing latency, lowering redundant computation, improving throughput, and increasing reliability and consistency of responses in a computer-implemented information processing system.

The term “communication path” refers to a logical connection established over a communication network that enables bidirectional transfer of digital information between a user terminal and a server.

The term “virtual private network connection” refers to a secure communication mechanism that creates an encrypted tunnel over a public or shared network to protect confidentiality and integrity of transmitted data.

The term “user terminal” refers to an information processing device operated by a user, including at least an input unit, an output unit, and a communication unit for interacting with a server over a network.

The term “voice input” refers to audio data representing spoken utterances of a user, captured by an audio acquisition component such as a microphone.

The term “character information” refers to digital textual data obtained by converting audio data or other input into a sequence of characters according to a predetermined encoding scheme.

The term “prompt sentence” refers to a text string provided as input to a generative AI model, the text string expressing a user request, a system instruction, or a combination thereof.

The term “analysis prompt sentence” refers to a prompt sentence specifically constructed to cause a generative AI model to perform analysis operations such as intent extraction or keyword extraction on user-provided information.

The term “generative AI model” refers to a machine learning model configured to generate natural language output or structured data based on an input prompt, using parameters learned from training data.

The term “user intention” refers to a semantic representation of a purpose or goal that a user intends to achieve through an input request.

The term “important terms” refers to key textual elements extracted from input information that are used for classification, routing, or selection of processing operations.

The term “functional module” refers to a software or hardware component that executes a specific type of processing operation, such as route guidance, information retrieval, or support response generation.

The term “business division” refers to an organizational unit or logical category within a service provider, to which processed information or tasks are routed based on content.

The term “processing operation” refers to a sequence of computational steps executed by the processor to perform a specific function, including but not limited to route guidance, information retrieval, and support processing.

The term “route guidance operation” refers to a processing operation that determines a path between locations and generates route information based on spatial and traffic-related data.

The term “information retrieval operation” refers to a processing operation that acquires relevant data from one or more storage units or external sources in response to a user request.

The term “support operation” refers to a processing operation that generates assistance information or advice in response to a user inquiry, including troubleshooting, procedural guidance, or explanatory content.

The term “geographic information data” refers to digital data representing spatial features such as coordinates, road segments, and landmarks used for location-related processing.

The term “traffic information data” refers to digital data representing conditions of transportation routes, including congestion, incidents, and travel speeds.

The term “business information data” refers to digital data related to internal operations, projects, resources, or services of an organization.

The term “external information source” refers to a system, service, or storage entity outside the server's internal storage that provides information via a communication network.

The term “source position information” refers to data identifying an origin of acquired information, including at least an address, identifier, or location within a network or database.

The term “reference link” refers to a network resource identifier, such as a uniform resource locator, that allows access to an original information source.

The term “reliability indicator” refers to data representing an evaluation of trustworthiness or quality of an information source, including but not limited to scores, ranks, or categorical labels.

The term “consistency of the acquired external information” refers to a degree to which acquired external information is compatible with predetermined rules, previously stored information, or multiple sources.

The term “emotion analysis” refers to a processing operation that determines an emotional state of a user by analyzing character information or voice information associated with the user.

The term “emotion type” refers to a category representing a kind of emotional state, including but not limited to anger, joy, sadness, anxiety, or neutrality.

The term “emotion intensity” refers to a quantitative or qualitative measure indicating a strength or degree of a detected emotion type.

The term “response-generation prompt sentence” refers to a prompt sentence constructed to cause a generative AI model to generate response content, the prompt sentence including at least user information, processing results, and emotion information.

The term “dialog-type response information” refers to natural language response data generated in a form suitable for conversational interaction between the user and the system.

The term “learning data” refers to stored data including input information, intermediate results, and output information used to adjust parameters of models or control logic in the system.

The term “analysis model” refers to a computational model used to analyze input information, including but not limited to models for intent detection, keyword extraction, classification, or emotion recognition.

The term “control parameter” refers to a numerical or logical value used to control behavior of the system, including thresholds, weights, and configuration values that affect processing operations and response generation.

The term “subsequent processing” refers to processing operations performed after storage of learning data, including future handling of user requests and internal computations influenced by updated parameters.

The term “response generation” refers to a processing operation in which the system produces natural language or structured output intended to be provided to the user as an answer to a request.

In an embodiment, a server, a terminal, and a user cooperate to implement the claimed system. The server includes at least one processor, a memory, a non-transitory storage medium, and a network interface. The terminal includes at least one processor, an audio input unit, a display, a loudspeaker, and a communication interface. The user operates the terminal to provide information in natural language.

The server uses a program stored in the non-transitory storage medium to control the processor. The program defines modules including a communication management module, a voice-to-text module interface, a prompt sentence generation module, a generative AI model interface module, an intent and keyword extraction module, a classification module, a domain processing module, an external source validation module, an emotion analysis module, a dialog generation module, a user interface support module, and a learning and model-update module.

The terminal uses a program stored in a non-transitory storage medium to control its processor. The terminal program defines modules including a VPN client module, an audio capture module, a voice recognition module, a prompt sentence transmission module, a display control module, a text-to-speech control module, and a feedback transmission module.

The server uses the communication management module and the VPN protocol to establish a secure communication path with the terminal. In one implementation, the server uses a generic VPN server component compatible with standard tunneling protocols, and the terminal uses a generic VPN client component. The VPN tunnel causes all application-level messages to be encapsulated and encrypted, which reduces the risk of interception and modification. From a technical perspective, this secure transport allows the server to assume integrity and confidentiality of payloads, and therefore to simplify error checking at higher layers while still complying with security constraints.

The terminal uses the audio capture module to acquire analog voice signals of the user via a microphone and converts them into digital audio frames. The terminal uses a voice recognition module, for example a cloud-based or on-device speech recognizer, to transform the digital audio into character information. In one example, the user says:

“Please show me the fastest route to the nearest gas station.”

The terminal converts this utterance into a text string forming a prompt sentence:

Please show me the fastest route to the nearest gas station.

The terminal attaches context such as a location coordinate and a usage scenario flag, but in the present description the prompt sentence itself is plain text as above.

The server receives the prompt sentence and stores it in the memory. The server uses the prompt sentence generation module to create a meta-level prompt sentence for analysis. For example, the server generates:

System: You are an intent extraction and keyword extraction engine.

User input: “Please show me the fastest route to the nearest gas station.”

Task: Identify the main intent and the important terms.

The server uses the generative AI model interface module to submit this analysis prompt sentence to a generative AI model. In one embodiment, the generative AI model is a transformer-based neural network trained on textual data. The model includes an embedding layer that maps discrete tokens to continuous vectors, a plurality of self-attention layers that compute context-dependent representations, and a feed-forward network that maps contextual representations to output distributions over tokens. The model uses a parameter set with millions or billions of weights stored in the server memory.

The server configures the model to output structured analysis, such as a short natural-language phrase or a delimited list. Internally, the intent and keyword extraction module parses the model output to obtain a user intention, such as “navigation request,” and important terms, such as “fastest route” and “gas station.” The module uses deterministic parsing rules such as pattern matching or delimiter splitting, and therefore the server does not rely on post-hoc human interpretation.

The server uses the classification module to map the user intention and important terms to a functional module. In this example, the functional module is a route guidance module. The mapping can use a rules-based structure stored as a table in the storage medium, in which rows associate combinations of intention labels and keywords with module identifiers. By using the generative AI model to pre-normalize and compress the semantic meaning into a limited set of labels and terms, the server reduces the dimensionality of the classification problem and lowers the computational cost of the rules-based classifier, compared to direct rule application on raw free text.

The server uses the domain processing module to perform operations specific to the selected module. For route guidance, the server accesses a spatial database storing road segments, nodes, and attributes such as speed limits. The server uses an algorithm such as A* search or contraction hierarchies to compute a path between an origin position and a destination location. The server may compute multiple candidate paths with different weightings for distance and time, and select the path with minimum estimated travel time under current traffic conditions.

The server uses the external source validation module to obtain traffic information or other external data. The server sends requests to external servers using standard network protocols and receives responses containing incident descriptions, congestion metrics, or other traffic indicators. For each piece of external information, the server attaches source position information (for example, a source identifier or network location), a reference link, and a reliability indicator. The reliability indicator can be calculated with a rules-based score combining factors such as whether the domain is in a trusted list, whether the content is consistent with other sources, or whether the timestamp is current. By encoding these as numerical fields, the server can automatically compare multiple sources and filter out low-reliability data, thus reducing the chance that inconsistent data propagate into downstream processing.

The server also uses the emotion analysis module to determine an emotional state from the prompt sentence. In one embodiment, the server employs a neural classifier distinct from the generative AI model. The classifier can be a smaller transformer or recurrent neural network taking as input an embedding sequence of the tokenized prompt sentence. The classifier outputs a probability distribution over emotion types and a score for each type. The server selects the emotion type with the highest score as the emotion type and stores the score as the emotion intensity. The server may use an objective function such as cross-entropy during training of this classifier and update weights using gradient descent to reduce error over labeled training examples.

In a security-support example, the user may input:

“Recently, it seems there was unauthorized access to my account. What should I do?”

The server receives the prompt sentence as text and performs intent extraction, determining that this is a “security support request.” The emotion analysis module may infer an emotion type of “anxiety” with a high intensity. The server then constructs a response-generation prompt sentence that includes both content and emotion:

User question: “Recently, it seems there was unauthorized access to my account. What should I do?”

Detected emotion: anxiety.

Task: Generate a step-by-step, reassuring security guide. Include actions such as changing a password, enabling multi-factor authentication, reviewing recent login activity, and contacting support.

The server passes this response-generation prompt sentence to the generative AI model. The dialog generation module receives the model output and converts it into dialog-type response information. For example, the model may produce:

First, immediately change your password to a new, strong password that you have not used before.

Next, enable multi-factor authentication if it is available.

Then, review your recent login history to check for suspicious activity.

Finally, contact the support desk and report the incident so they can investigate further.

The server stores the response in memory along with the corresponding intent, emotion type, emotion intensity, and reliability indicators for any external data used. The server sends the response to the terminal over the VPN-protected connection.

The terminal uses the display control module to display the text in a chat-like user interface. The terminal uses the text-to-speech module to synthesize audio spoken output, sending audio samples to the loudspeaker. The terminal thus provides a multimodal response, and the user can read and listen to the answer.

The server uses the learning and model-update module to record learning data. The learning data includes the original prompt sentence, the extracted intention and important terms, the classification result, the processing result, the emotion data, the response text, and any user feedback. The server stores this data in a database using a structured format that associates each request with its outcome. At configured intervals, the server loads portions of this learning data and recalculates control parameters such as thresholds for emotion intensity, routing rules, or weights in a reliability scoring function.

In some implementations, the server uses the learning data to fine-tune the generative AI model or the emotion classifier. The server defines a loss function, such as a cross-entropy loss between predicted labels and corrected labels derived from user feedback, or a regression loss between predicted satisfaction and observed feedback scores. Using optimization algorithms such as stochastic gradient descent, the server updates model weights stored in the memory. In doing so, the server modifies the internal representation spaces of the models such that future inferences require fewer tokens or produce more accurate labels for the same type of input. This adjustment reduces the average number of iterations or sampling steps required to reach stable outputs, contributing to improved processing speed and lower computational load.

The described architecture improves computer technology by combining multiple computational layers in a non-traditional sequence. Instead of using generative AI models only at the final interface stage, the server systematically uses prompt sentences to make the generative AI model perform both low-level analysis (intent and keyword extraction) and high-level dialog generation. Because the server converts the user prompt sentence into an analysis prompt sentence that restricts the type and format of output, the server can treat the generative AI model as a programmable, general-purpose parser and classifier rather than a purely generative engine. This reduces the need for separately trained traditional classifiers, thereby decreasing memory usage and avoiding the overhead of separate model loading and inference calls.

The emotion-aware prompt construction also modifies the behavior of the generative AI model in a controlled manner. The server does not simply adjust wording at the user interface; instead, the server includes the emotion type and intensity as structured control inputs in the response-generation prompt sentence. The generative AI model uses these inputs during its internal attention computations and output token selection. As a result, the model converges faster to suitable responses and reduces the number of tokens required to express the result, which lowers bandwidth consumption between the server and the terminal and reduces the time the processor spends executing the attention and feed-forward layers.

The classification module and routing logic are implemented as data structures within the server. For example, a mapping table may use a key composed of an intention label and a list of important terms, and the value may be an identifier of a functional module. The server can efficiently access this table using a hash-based index, which avoids linear searches through large rule sets. By standardizing the intention labels and important terms through the generative AI model, the variation in input keys is reduced, improving cache locality and further speeding up routing decisions.

The external source validation module uses a combination of a trust list and numerical scoring rules. For instance, the server may assign a base score to each domain name, increase the score when multiple independent sources agree on the same content, and decrease the score when the timestamp is too old or the format is irregular. The server stores these scores as numeric fields and can filter or sort candidate sources using vectorized operations in the database engine. This structure enables fast selection of reliable data and reduces the quantity of low-quality data that must be transmitted to and processed by the generative AI model.

In another embodiment, the server uses the same basic architecture to classify support inquiries into internal categories. The user may enter a prompt sentence such as:

“Please tell me how to use the new product.”

The server constructs an analysis prompt sentence:

Task: Extract important keywords from the following text.

Text: “Please tell me how to use the new product.”

Output keywords as a comma-separated list.

The generative AI model returns keywords such as “new product, usage.” The server applies a rules-based classifier that maps these keywords to a particular support category. Because the model has already reduced the complex sentence to a small list of normalized keywords, the rules-based classifier can be simple and fast. The server can further pass a response-generation prompt sentence:

Department: Product Support.

User question: “Please tell me how to use the new product.”

Task: Generate a helpful, concise explanation and suggest a link to the user manual.

The generative AI model generates a structured answer. The server wraps the answer with additional metadata and transmits it to the terminal. The terminal then displays the information in a chat-style interface.

In a navigation-focused variation, the server may emphasize route optimization and device control. The server receives a prompt sentence, such as:

“Guide me to the nearest hospital without using toll roads.”

The server identifies the intention as navigation and the important terms as “nearest hospital” and “without toll roads.” The server configures the route guidance module to assign a large penalty weight to road segments marked as toll roads in the geographic information data. The server uses the route result to drive rendering parameters on the terminal map display, highlighting the route and controlling the zoom level. Here, the system integrates natural language processing with device-level control, as the route geometry directly influences visual rendering and audio guidance timing on the terminal.

In each of these embodiments, the server performs a series of concrete data transformations on specific data structures. The server converts audio to character information, converts character information to vector representations, converts vector representations to labels and keywords, converts labels and keywords to functional-module identifiers, converts domain data to route paths or support content, and converts these results back into human-readable sentences. At each stage, the server uses deterministic or parameterized algorithms implemented in software running on a physical processor, which affects memory usage, CPU cycles, and network traffic in measurable ways. These effects go beyond the mere automation of human judgment by modifying fundamental aspects of how the computer system organizes and processes data, thereby improving throughput, latency, and accuracy.

Alternative implementations can replace or extend specific modules. For example, the emotion analysis module can use a convolutional neural network instead of a transformer, or a hybrid model that uses acoustic features from the original audio in addition to text features. The route guidance module can use different pathfinding algorithms or heuristics. The generative AI model can be hosted locally on the server hardware or accessed from a separate computation node. The core aspects remain the coordinated use of prompt sentences, generative AI model operations, internal classification structures, emotion-aware control, and continual learning to optimize computer-level performance.

By defining precise internal data flows, modular responsibilities, and learning-based parameter updates, the system enables the server and the terminal to cooperate in a way that enhances technical performance and scalability. The system reduces redundant computations by centralizing analysis and generation in a generative AI model with controlled prompt sentences, accelerates routing decisions through standardized labels and keywords, and increases reliability by binding external data to structured source and trust metadata. As a result, the server and the terminal implement an improved computer-implemented information processing system that can execute complex, context-and emotion-aware functions with enhanced speed, accuracy, and resource efficiency.

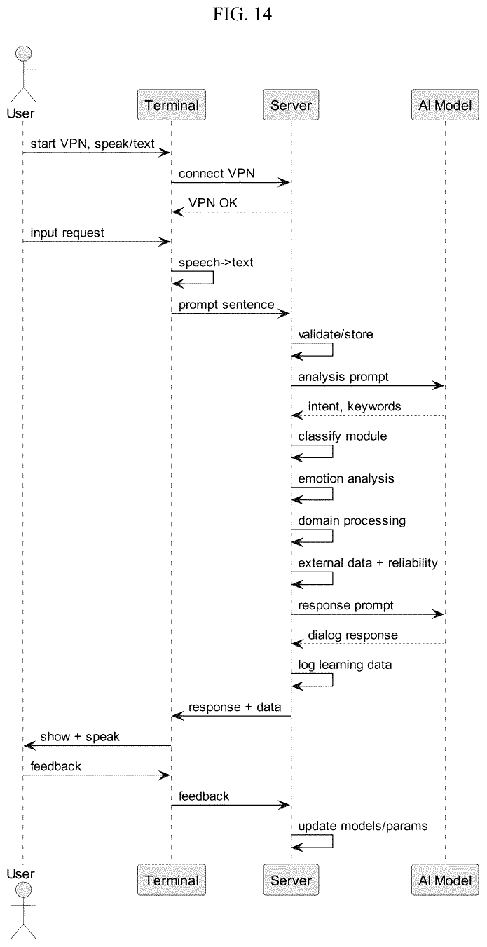

The following describes the processing flow using FIG. 14.

### Step 1

User activates secure connection and interface

User starts a client application on the terminal and initiates a virtual private network connection.

Input: User credentials (for example, ID, password, token) and a connection request.

Output: An established encrypted tunnel between the terminal and the server.

Terminal uses a VPN client module to encapsulate and encrypt all outgoing packets and to authenticate with the server.

Server uses a VPN server module to verify credentials, assign a virtual address, and create a session record in memory and in storage.

### Step 2

User provides a natural language request

User speaks or types a request into the terminal, such as:

“Please show me the fastest route to the nearest gas station.”

or

“Recently, it seems there was unauthorized access to my account. What should I do?”

Input: User speech or text in natural language.

Output: Raw audio frames or raw text stored in the terminal.

Terminal uses a microphone interface to sample audio signals and buffer them, or uses a text input control to capture characters, and stores the input in a local buffer.

### Step 3

Terminal converts voice to text and forms a prompt sentence

Terminal processes the raw audio using a voice recognition module to produce a text representation.

Input: Digital audio frames representing the user's voice.

Output: A text string forming a prompt sentence, for example:

Please show me the fastest route to the nearest gas station.

Terminal applies acoustic feature extraction (for example, Mel-frequency cepstral coefficients) and a speech recognition algorithm to map audio frames to phonemes and then to characters.

Terminal normalizes the recognized text (for example, trimming spaces, fixing obvious recognition errors) and designates it as a prompt sentence.

### Step 4

Terminal packages and sends the prompt sentence to the server

Terminal creates a request message containing the prompt sentence and associated context.

Input: Prompt sentence text and context data (for example, GPS coordinate, language code, scenario flag).

Output: A structured message transmitted to the server over the VPN.

Terminal encodes the data in a predefined request format, encrypts it at the transport layer via the VPN, and forwards it through the communication interface to the server.

### Step 5

Server receives and validates the user request

Server accepts the incoming message from the terminal and checks its integrity.

Input: Encrypted request message containing the prompt sentence and context.

Output: Validated prompt sentence and context stored in server memory.

Server decrypts the packet at the VPN layer, parses the application payload, verifies required fields (for example, presence of prompt sentence, session ID), and discards malformed or unauthorized requests.

Server stores the prompt sentence and context in a request table with a new request identifier.

### Step 6

Server prepares an analysis prompt sentence for the generative AI model

Server constructs a secondary prompt sentence that instructs the generative AI model to perform analysis.

Input: Original prompt sentence from the user.

Output: Analysis prompt sentence formatted for the generative AI model, for example:

System: You are an intent extraction and keyword extraction engine.

User input: “Please show me the fastest route to the nearest gas station.”

Task: Identify the main intent and the important terms.

Server concatenates fixed template strings with the user prompt sentence, inserts delimiters, and stores the resulting text in an internal buffer for model input.

### Step 7

Server sends the analysis prompt sentence to the generative AI model and obtains analysis output

Server uses a model interface to submit the analysis prompt sentence to a generative AI model.

Input: Analysis prompt sentence text.

Output: Model-generated analysis text containing labels and important terms.

Server tokenizes the analysis prompt sentence into a sequence of token IDs, passes the sequence to a transformer-based generative AI model, and receives an output token sequence representing analysis content (for example, “intent: navigation_request; keywords: fastest route, gas station”).

Server decodes the model output tokens into characters and a text string.

### Step 8

Server extracts user intention and important terms from the model output

Server parses the analysis text to separate an intention label and important terms.

Input: Analysis result text from the generative AI model.

Output: A structured representation containing a user intention and a list of important terms.

Server applies deterministic parsing rules, such as splitting by punctuation or keywords like “intent:” and “keywords:,” to isolate fields.

Server converts the extracted fields into standardized labels and stores them in memory as a structured data object.

### Step 9

Server classifies the request into a functional module

Server decides which internal module should handle the request based on the user intention and important terms.

Input: User intention label and important terms list.

Output: Identifier of a functional module (for example, route guidance, information retrieval, or support).

Server uses a rules table or mapping function that matches combinations of intention labels and keywords to module identifiers.

Server performs a lookup using the structured data as a key, obtains the target module name, and records the selected module in the request record.

### Step 10

Server performs emotion analysis on the prompt sentence

Server determines an emotional state from the user's original text.

Input: Original prompt sentence (for example, “Recently, it seems there was unauthorized access to my account. What should I do?”).

Output: An emotion type (for example, anxiety) and an emotion intensity value.

Server encodes the text as a token sequence or as vector embeddings and feeds the sequence into an emotion classifier model.

Server computes a probability distribution over multiple emotion classes, selects the class with the highest probability as the emotion type, and stores the maximum probability as the emotion intensity.

### Step 11

Server executes domain-specific processing for the selected module

Server runs logic associated with the functional module chosen in classification.

Input: Module identifier, user intention, important terms, and context (for example, location, account reference).

Output: Domain-specific processing result (for example, a computed route, retrieved information, or support content parameters).

For navigation, server queries a geographic database with the user's location and destination type, applies a pathfinding algorithm to generate a route, and stores route geometry and metadata.

For security support, server retrieves internal policy data and generates a list of recommended actions or checks specific to the user's scenario.

### Step 12

Server acquires and validates external information sources

Server contacts external servers or services to obtain supplemental data (for example, traffic status or threat advisories).

Input: Domain-specific query parameters (for example, region identifier, topic keyword).

Output: External information items annotated with source position information, a reference link, and a reliability indicator.

Server sends network requests to external endpoints, receives responses, and extracts relevant fields.

Server attaches source identifiers, generates or records reference links, computes a reliability score using predefined scoring rules, and discards items below a threshold.

### Step 13

Server constructs a response-generation prompt sentence incorporating emotion and processing results

Server prepares a new prompt sentence that instructs the generative AI model to generate a dialog-type response.

Input: Domain-specific processing result, emotion type, emotion intensity, and any validated external data.

Output: Response-generation prompt sentence text, for example:

User question: “Recently, it seems there was unauthorized access to my account. What should I do?”

Detected emotion: anxiety.

Task: Generate a step-by-step, reassuring security guide, including concrete actions and a calm tone.

Server merges these elements into a structured text including explicit instructions about tone, structure, and required content, and stores the final text as the model input.

### Step 14

Server generates dialog-type response information using the generative AI model

Server uses the generative AI model to create natural language output in response to the response-generation prompt sentence.

Input: Response-generation prompt sentence.

Output: Dialog-type response text suitable for presentation to the user.

Server tokenizes the prompt sentence and feeds the token sequence into the generative AI model operating in a generation mode.

Server iteratively samples or selects next tokens based on model probabilities until reaching an end condition, decodes the tokens to characters, and obtains a completed response text (for example, multi-step guidance or a detailed route explanation).

### Step 15

Server post-processes and stores the response with metadata as learning data

Server refines the generated text and updates learning records.

Input: Raw dialog-type response text, classification result, domain-specific result, emotion data, and source information.

Output: Cleaned response text ready for transmission and a learning record stored in persistent storage.

Server may normalize line breaks, remove unwanted tokens, and segment the text into logical units.

Server creates a learning data record linking the prompt sentence, extracted intention, important terms, module identifier, processing result, emotion values, external sources, and final response, and stores this record in a database.

### Step 16

Server sends the response to the terminal

Server transmits the finalized response text and any structured data to the terminal over the secure channel.

Input: Cleaned dialog-type response text and structured domain data (for example, route coordinates, links).

Output: Response message delivered to the terminal for presentation.

Server encodes the response into a response message, encrypts it via the VPN layer, and sends it using the network interface.

### Step 17

Terminal presents the response to the user

Terminal receives the response message and renders it for the user.

Input: Response message containing dialog-type response text and structured data.

Output: Visual display and audio output of the response.

Terminal parses the message, draws route paths on a map or displays support instructions as text, and uses a text-to-speech module to synthesize and play back spoken guidance.

User reads and listens to the response and optionally follows the suggested route or operations.

### Step 18

User provides feedback and terminal sends it to the server

User indicates satisfaction or dissatisfaction, or adds comments through the interface.

Input: User feedback (for example, rating, short comment) entered at the terminal.

Output: Feedback message transmitted to the server.

Terminal captures the feedback, associates it with the corresponding request, and transmits a feedback message to the server over the VPN connection.

### Step 19

Server updates models and control parameters based on learning data

Server uses accumulated learning data and feedback to improve future processing.

Input: Stored learning records and new feedback data.

Output: Updated analysis models and control parameters (for example, routing thresholds, reliability weights, emotion thresholds).

Server executes periodic training or adjustment routines that recalculate model weights or rule thresholds using optimization algorithms, and writes the updated parameters back to memory or persistent storage.

Server thereby refines intent detection, emotion analysis, classification, and response style, which improves processing accuracy and efficiency in subsequent executions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

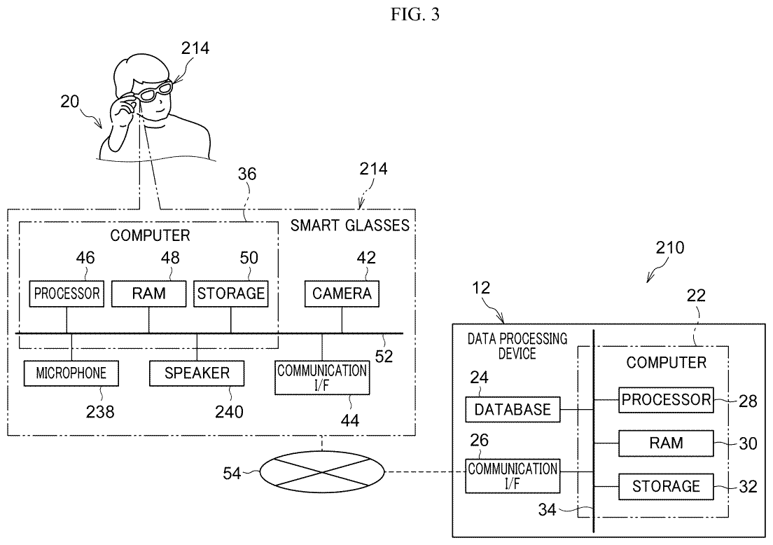

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

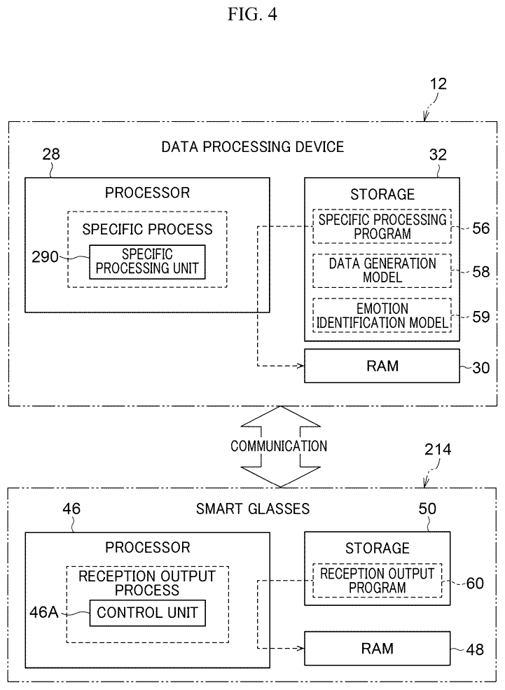

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

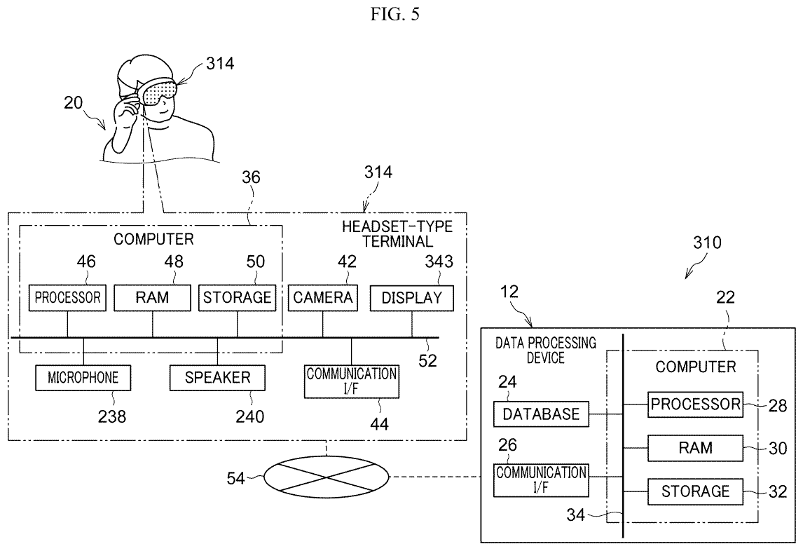

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

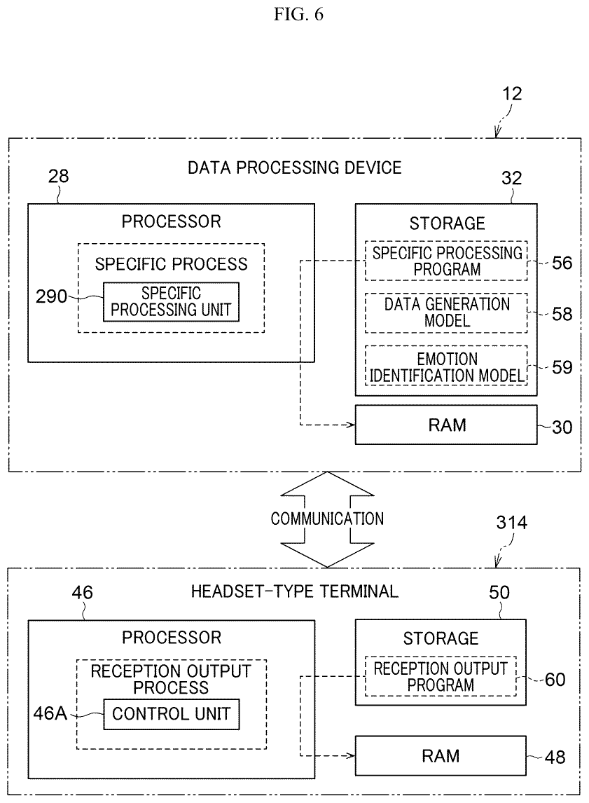

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

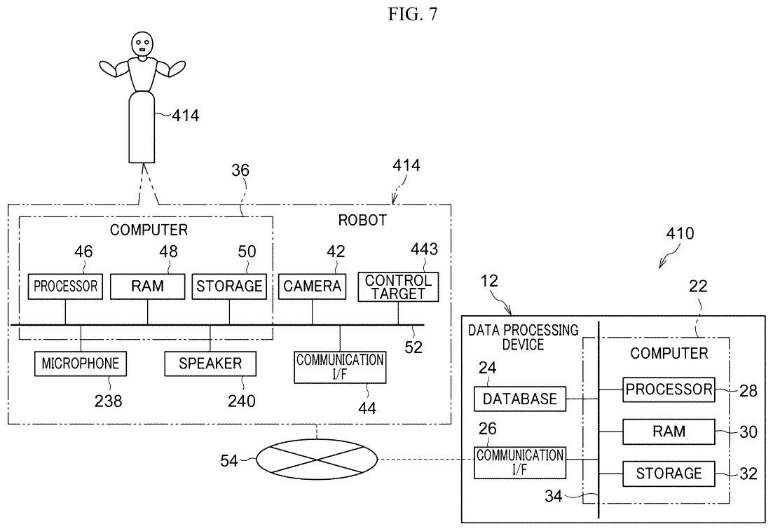

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

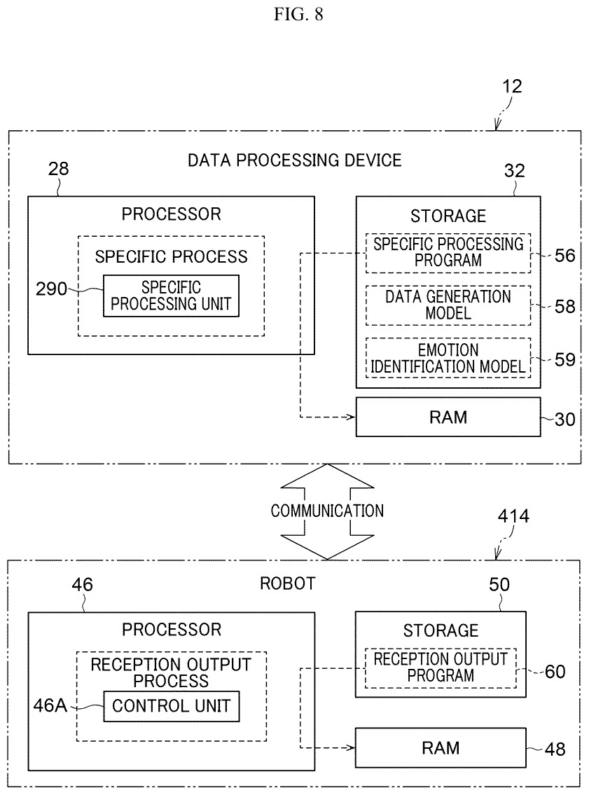

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

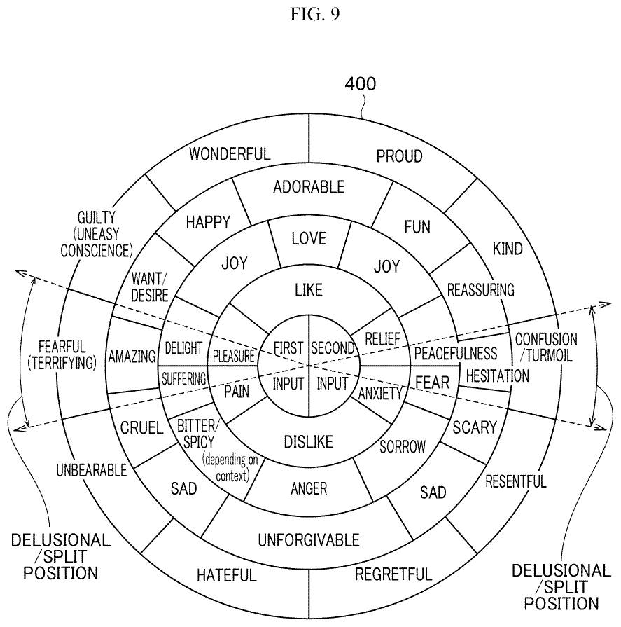

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

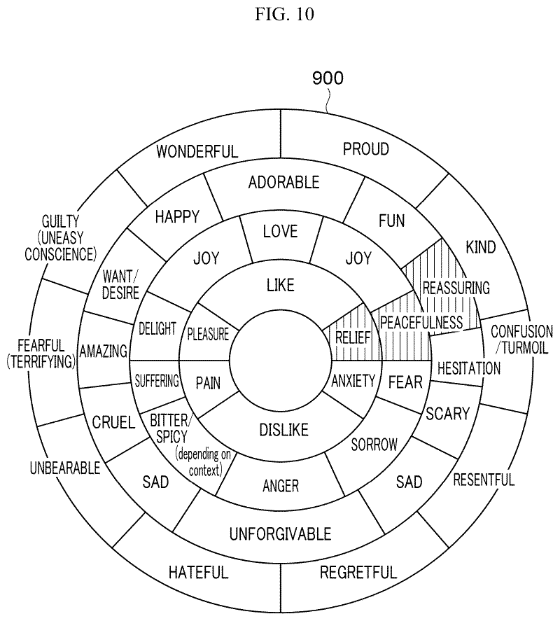

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
establish, via a public communication network, a virtual private communication path with a user terminal so as to generate an encrypted communication channel for securely receiving information from the user terminal, and
receive, from the user terminal, a search query and a natural language prompt sentence through a search interface and a dialog interface displayed on the user terminal, and search an information storage device having an index structure for information retrieval based on the search query to acquire related information, and
construct input data for a generative AI model that is a natural language processing model based on the prompt sentence and the related information, request an inference process to the generative AI model, and generate a dialog-type response sentence, and
associate, when generating the response sentence, identification information that identifies an acquisition source of the related information with the response sentence so as to specify an information source, and transmit reference information for the information source to the user terminal for display, and
record past prompt sentences, response sentences, search results, and evaluation information from a user, and execute a learning process to improve accuracy of future responses by updating, based on the recorded information, at least one of an information acquisition condition, a method of constructing the input data, and an inference condition of the generative AI model, and
identify information or response sentences repeatedly requested by a plurality of users, store the identified information or response sentences in a high-speed reference storage device, and
shorten response time by reading the information or response sentences from the high-speed reference storage device in response to subsequent requests.

### Supplementary 2

The system according to supplementary 1,
wherein the processor is configured to
select information from a plurality of pieces of the related information acquired by the search query based on importance when constructing the input data for the generative AI model, generate an extended prompt sentence by adding the selected information to the prompt sentence, and generate the response sentence by inputting the extended prompt sentence to the generative AI model.

### Supplementary 3

The system according to supplementary 1,
wherein the processor is configured to
classify the recorded prompt sentences and response sentences in the learning process, and dynamically optimize at least one of an information retrieval process and a response generation process by changing a weighting parameter of the index structure for information retrieval or a control parameter for the generative AI model according to a classification result.

### Application Example 1

### Supplementary 1

A system comprising a processor,
wherein the processor is configured to
use a virtual private network connection to securely receive information from a user terminal and acquire position information and destination information of a user, and
acquire a plurality of route information items from a route guidance information processing resource based on the acquired position information and destination information, and
acquire traffic information and weather information corresponding to the plurality of route information items from an external information providing resource and associate and integrate the route information with the traffic information and the weather information, and
calculate, for each route, a time indicator and a safety indicator based on the integrated information and evaluate and rank the plurality of route information items based on the time indicator and the safety indicator, and
receive a natural language inquiry sentence from the user and analyze the inquiry sentence to extract an intention of the user and constraint conditions, and
generate a prompt sentence to be input to a generative AI model based on the evaluated and ranked route information items and the intention of the user and the constraint conditions, and
transmit the prompt sentence to the generative AI model and obtain, from the generative AI model, a response sentence including route selection reasons and guidance content, and
acquire identification information, link information, and update time information regarding map information resources, traffic information resources, and weather information resources used for generation of the route information, and generate presentation information associated with the response sentence, and
transmit guidance information including the response sentence and the presentation information to the user terminal, and
accumulate evaluation information of the user regarding the guidance information and travel history information and update, in a learning manner, at least one parameter of a route evaluation process and a prompt sentence generation process based on the accumulated information.

### Supplementary 2

The system according to supplementary 1,
wherein the processor is configured to
control the generation of the prompt sentence such that the prompt sentence describes the time indicators and the safety indicators of the plurality of route information items in a comparable format and includes summaries of traffic conditions and weather conditions for each route so that the response sentence generated by the generative AI model becomes route guidance explanation with reasons understandable to the user.

### Supplementary 3

The system according to supplementary 1,
wherein the processor is configured to
update, based on the evaluation information of the user, parameters for adjusting an expression style and a level of detail of explanation content in the prompt sentence input to the generative AI model so as to adapt an amount of explanation and emphasis points in subsequent response sentences to preferences of the user.

### Example 2

### Supplementary 1

A system comprising a processor,
wherein the processor is configured to
establish and maintain a virtual private network connection to securely receive user information from a terminal, and
receive a user inquiry expressed in natural language from the terminal, acquire the inquiry as character information, and perform preprocessing of the character information, and
generate a prompt sentence for using a generative AI model with respect to the character information, and transmit inquiry data including the prompt sentence and the character information to the generative AI model, and
acquire response information from the generative AI model, refer to structured information stored in an information resource storage device, and identify a related information providing source, and append source information relating to the information providing source to the response information, and
transmit the response information with the appended source information to the terminal via a communication network and cause the terminal to output the response information as display information in a dialog format, and
receive, from the terminal, an additional user inquiry based on the response information and the source information, and execute continuous dialog processing by transmitting, to the generative AI model, the additional inquiry together with context information including a past inquiry history and the prompt sentence, and
extract important terms from the response information received from the generative AI model, and automatically classify the user information into work processing units based on the important terms.

### Supplementary 2

The system according to supplementary 1,
wherein the processor is configured to
generate reference link information to an information providing source to be displayed on the terminal, based on the response information acquired from the generative AI model and the structured information acquired from the information resource storage device, and include the reference link information in the source information to be output.

### Supplementary 3

The system according to supplementary 1,
wherein the processor is configured to
analyze expressions included in the user inquiry expressed in natural language and in the response information obtained from the generative AI model, estimate an emotional state of the user, and adjust at least one of the prompt sentence and an expression of the response information according to the emotional state.

### Application Example 2

### Supplementary 1

A system comprising a processor,
wherein the processor is configured to
establish a communication path using a virtual private network connection in order to securely receive information from a user terminal,
convert voice input provided by a user into character information and generate a prompt sentence,
generate, using the prompt sentence as input, an analysis prompt sentence for a generative AI model and use the generative AI model to extract a user intention and important terms, automatically classify the information into a predetermined functional module or business division based on the important terms and the user intention,
select at least one processing operation among a route guidance operation, an information retrieval operation, and a support operation according to the user intention, and execute the selected processing operation using geographic information data, traffic information data, or business information data,
perform communication with an external information source, and, for acquired information, add source position information, a reference link, and a reliability indicator and verify consistency of the acquired information,
perform emotion analysis using character information or voice information received from the user, and identify an emotion type and an emotion intensity,
generate a response-generation prompt sentence in which the emotion type and the emotion intensity are taken into account, and use the generative AI model to generate dialog-type response information, and
store the generated response information, the classification result, the processing result, and information regarding the information source as learning data, and update parameters so as to improve subsequent processing and response generation.

### Supplementary 2

The system according to supplementary 1,
wherein the processor is configured to provide a user interface that displays and outputs by sound route information, procedure information, or support information by using guidance information included in the dialog-type response information.

### Supplementary 3

The system according to supplementary 1,
wherein the processor is configured to update an analysis model or a control parameter so as to improve at least one processing performance among the emotion analysis, the automatic classification of the information, and the generation of the dialog-type response information, based on the stored learning data.

What is claimed is:

1. A system comprising:
a communication interface connected to a packet-switched network; and
circuitry configured to:
establish, via the communication interface, an encrypted communication channel with a terminal device over the packet-switched network;
receive, through the encrypted communication channel, input data comprising a natural-language query from the terminal device;
perform natural-language processing on the input data to extract a set of feature terms from the natural-language query;
construct, based on the input data and the set of feature terms, a prompt data structure configured to instruct a generative neural network model to produce an analysis of the input data;
transmit the prompt data structure to the generative neural network model via the communication interface;
receive, from the generative neural network model, output data comprising a classification result and response content generated in response to the prompt data structure;
determine, based on the classification result and the set of feature terms, a routing destination from among a plurality of processing modules stored in a data storage device; and
transmit, via the encrypted communication channel, the response content to the terminal device.

2. The system according to claim 1, wherein the circuitry is further configured to:
search an information storage structure having an index for information retrieval based on at least a portion of the set of feature terms to acquire related information; and
include the related information in the prompt data structure prior to transmitting the prompt data structure to the generative neural network model.

3. The system according to claim 2, wherein the circuitry is further configured to:
associate identification information that identifies an acquisition source of the related information with the response content; and
transmit reference information for the acquisition source to the terminal device together with the response content.

4. The system according to claim 2, wherein the circuitry is further configured to:
select, from a plurality of items of the related information, a subset based on an importance score; and
construct an extended prompt data structure by appending the subset to the prompt data structure.

5. The system according to claim 1, wherein the circuitry is further configured to:
record, in the data storage device, a history comprising the prompt data structure, the response content, and evaluation information received from the terminal device; and
update, based on the recorded history, at least one of an information retrieval parameter, a construction rule for the prompt data structure, and an inference parameter of the generative neural network model.

6. The system according to claim 5, wherein the circuitry is further configured to:
classify the recorded prompt data structures and response content; and
adjust a weighting parameter of the index for information retrieval or a control parameter of the generative neural network model based on a classification result of the recorded data.

7. The system according to claim 1, wherein the circuitry is further configured to:
identify response content that has been requested by a plurality of terminal devices exceeding a frequency threshold;
store the identified response content in a cache storage device; and
retrieve the identified response content from the cache storage device in response to a subsequent request matching the identified response content.

8. The system according to claim 1, wherein the generative neural network model comprises a transformer architecture including an embedding layer, a plurality of self-attention layers, a plurality of feed-forward layers, and an output projection layer.

9. The system according to claim 8, wherein the circuitry is further configured to configure decoding parameters of the generative neural network model comprising at least a maximum token length and a sampling strategy parameter.

10. The system according to claim 1, wherein the circuitry is further configured to:
receive, from the terminal device via the encrypted communication channel, location data and destination data;
acquire, from at least one external information source via the communication interface, a plurality of route data items based on the location data and the destination data;
acquire traffic data and environmental condition data corresponding to each of the plurality of route data items; and
compute, for each route data item, at least one time metric and at least one safety metric based on the traffic data and the environmental condition data, and rank the plurality of route data items based on the at least one time metric and the at least one safety metric.

11. The system according to claim 10, wherein the circuitry is further configured to:
include the ranked route data items in the prompt data structure; and
receive, from the generative neural network model, the response content comprising a route selection rationale and guidance content based on the ranked route data items.

12. The system according to claim 1, wherein the circuitry is further configured to:
convert voice data received from the terminal device into character data using a speech recognition model; and
perform the natural-language processing on the character data to extract the set of feature terms and a user intention indicator.

13. The system according to claim 12, wherein the circuitry is further configured to:
select, based on the user intention indicator, at least one processing operation from among a route guidance operation, an information retrieval operation, and a support operation; and
execute the selected processing operation using data stored in the data storage device.

14. The system according to claim 1, wherein the circuitry is further configured to:
estimate an emotional state of a user based on at least one of voice data, image data, and text data received from the terminal device; and
include the emotional state in the prompt data structure to cause the generative neural network model to adjust at least one of a tone, a level of detail, and a structure of the response content.

15. The system according to claim 14, wherein the emotional state is estimated using an emotion identification model that maps input data to emotion values on an emotion map in which a plurality of emotions are arranged based on a structure giving rise to the emotions.

16. The system according to claim 1, wherein the encrypted communication channel is a virtual private network tunnel established using an encryption protocol over the packet-switched network.

17. The system according to claim 1, wherein the circuitry is further configured to:
acquire, from an external information source via the communication interface, external data associated with the response content;
associate source position information, a reference link, and a reliability indicator with the external data; and
verify consistency of the external data prior to including the external data in the response content.

18. A system comprising:
a communication interface connected to a packet-switched network;
a data storage device; and
circuitry configured to:
establish an encrypted communication channel with a terminal device via the communication interface;
receive input data comprising a natural-language query through the encrypted communication channel;
extract feature terms from the input data using natural-language processing;
search an information storage structure based on the feature terms to acquire related information;
construct a prompt data structure based on the input data, the feature terms, and the related information;
transmit the prompt data structure to a generative neural network model and receive output data comprising a classification result and response content;
associate source identification information with the response content;
determine a routing destination based on the classification result; and
transmit the response content and the source identification information to the terminal device via the encrypted communication channel.

19. A method comprising:
establishing, by circuitry via a communication interface connected to a packet-switched network, an encrypted communication channel with a terminal device;
receiving, through the encrypted communication channel, input data comprising a natural-language query;
performing, by the circuitry, natural-language processing on the input data to extract a set of feature terms;
constructing, by the circuitry, a prompt data structure based on the input data and the set of feature terms, the prompt data structure configured to instruct a generative neural network model;
transmitting the prompt data structure to the generative neural network model and receiving output data comprising a classification result and response content;
determining, based on the classification result, a routing destination from among a plurality of processing modules; and
transmitting the response content to the terminal device via the encrypted communication channel.
